(19) United States
(12) Patent Application Publication
(10) Pub. No.: US 2026/0359790 A1
(43) Pub. Date: Nov. 12, 2026

(54) SCORING AND RANKING OF CANDIDATE RESPONSES FOR A JOB INITIATION REQUEST

(71) Applicant: Oracle International Corporation, Redwood Shores, CA (US)

(72) Inventors: Vikas Agrawal, Hyderabad (IN); Dipawesh Pawar, Karnataka (IN); Krishnan Ramanathan, Karnataka (IN); Jagdish Chand, Pleasanton, CA (US)

(73) Assignee: Oracle International Corporation, Redwood Shores, CA (US)

(21) Appl. No.: 19/205,674

(22) Filed: May 12, 2025

(51) Int. Cl. G06Q 10/1053; G06F 40/279; G06F 40/30; G06F 40/40

(52) U.S. Cl. CPC G06Q 10/1053; G06F 40/279; G06F 40/30; G06F 40/40

(57) ABSTRACT

Techniques for automated evaluation of candidate responses to a natural-language job initiation request are disclosed. A trained language model transforms the natural-language job initiation request into a structured data representation including a first set of conditions associated with a first classification category, and a second set of conditions associated with a second classification category. For each condition in the first and second sets, a corresponding relevance score is calculated, based on semantic alignment between the condition and a contextual representation of the job initiation request. For each condition, a condition match score between a textual content of a candidate response to the job initiation request and the condition is calculated. A composite response score for the candidate response is computed. Based on the composite response score, a ranked list of candidate responses is generated. At least a portion of the ranked list is caused to be presented on a display.

### BACKGROUND

When an organization decides to hire for a new job position, a job description is posted for the job position. The job description may be advertised on a website of the organization, websites of one or more contractors contracted by the organization (such as hiring websites), and/or one or more third party websites, although other channels for job advertisement (such as newspapers, trade journals, etc.) may also be used. In response to the job posting, responses are received from prospective candidates applying for the job position. Reviewing, sorting, scoring, ranking, and/or selecting responses for multiple job positions may be time and resource consuming, and is a nontrivial task.

### BRIEF SUMMARY

In various embodiments, a computer-program product tangibly embodied in a non-transitory machine-readable storage medium, includes instructions configured to cause one or more data processors to perform a set of operations including: receiving, via an input interface, a natural-language job initiation request; transforming, by a computing system, the natural-language job initiation request into a structured data representation using a trained language model, wherein the structured data representation comprises a plurality of conditions associated with the job initiation request; determining, for each condition of the plurality of conditions, a corresponding relevance score based at least in part on semantic alignment between the condition and a contextual representation of the job initiation request; accessing, by the computing system, textual content of a candidate response to the job initiation request; for each condition, calculating a condition match score between the textual content of the candidate response and the condition using at least a vector similarity function; computing a composite response score for the candidate response by aggregating a weighted combination of: the relevance scores associated with the conditions, and the corresponding condition match scores; generating, based on the composite response score, a ranked list of candidate responses; and causing presentation of at least a portion of the ranked list on a display associated with the computing system.

In an example, the plurality of conditions comprises (i) a first set of conditions assigned to a first classification category, and (ii) a second set of conditions assigned to a second classification category; a first category score and a second category score are assigned to the first classification category and the second classification category, respectively; and the weighted combination further includes a weight of the category score. In an example, the composite response score for the candidate response is based on an aggregation of at least: (i) a product of the first category score, a first relevance score of a first condition assigned to the first classification category, and a first condition match score between the textual content of the candidate response and the first condition; and (ii) a product of the second category score, a second relevance score of a second condition assigned to the second classification category, and a second condition match score between the textual content of the candidate response and the second condition. In an example, the first classification category is representative of one of (i) one or more mandatory requirements extracted by the trained language model from the job initiation request, (ii) one or more preferred requirements extracted by the trained language model from the job initiation request, (iii) one or more job responsibilities extracted by the trained language model from the job initiation request, and (iv) one or more soft skill requirements extracted by the trained language model from the job initiation request; and the second classification category is representative of another one of (i) the one or more mandatory requirements extracted by the trained language model from the job initiation request, (ii) the one or more preferred requirements extracted by the trained language model from the job initiation request, (iii) the one or more job responsibilities extracted by the trained language model from the job initiation request, and (iv) the one or more soft skill requirements extracted by the trained language model from the job initiation request.

In an example, transforming the natural-language job initiation request into the structured data representation comprises: using the trained language model, extracting, from the job initiation request, the plurality of conditions, such that the conditions are non-duplicative of each other. In an example, transforming the natural-language job initiation request into the structured data representation comprises: using the trained language model, iteratively extracting from the job initiation request and refining the plurality of conditions, until a difference between condition spaces of two consecutive iterations is less than a threshold and/or until a prespecified threshold number of iterations have been performed, wherein a condition space of a given iteration includes a corresponding plurality of conditions generated during the given iteration.

In an example, determining, for each condition, the corresponding relevance score comprises: determining, for each condition of the plurality of conditions, the corresponding relevance score based further at least in part on a criticality measure of the condition with respect to the job initiation request, the criticality measure estimated using a trained embedding model. In an example, determining, for each condition, the corresponding relevance score comprises: determining, for each condition of the plurality of conditions, the corresponding relevance score based further at least in part on a market demand of a requirement specified within the corresponding condition. In an example, calculating the condition match score comprises: extracting a text portion from the textual content of the candidate response, the text portion being at least a partial match to the condition; generating a forward-match metric that estimates an extent to which the text portion matches the condition; generating a reverse-match metric that estimates an extent to which the condition matches the text portion; and calculating the condition match score, based at least in part on the forward-match metric and/or the reverse-match metric.

In an example, calculating the condition match score further comprises: calculating the condition match score to be a lower of the forward-match metric and the reverse-match metric. In an example, calculating the condition match score comprises: extracting a text portion from the textual content of the candidate response, the text portion being at least a partial match to the condition; and calculating the condition match score, based at least in part on an extent of match between the text portion and the condition. In an example, the set of operations further include: selecting first one or more candidate responses from the ranked list of candidate responses for a subsequent stage of a hiring process associated with the job initiation request; and rejecting second one or more candidate responses from the ranked list of candidate responses for the subsequent stage of the hiring process associated with the job initiation request, wherein at least one of the selected first one or more candidate responses has a higher composite response score than at least one of the rejected second one or more candidate responses. In an example, selecting the first one or more candidate responses and rejecting the second one or more candidate responses comprises: in response to each of the first one or more candidate responses having the corresponding composite response score higher than a threshold value, selecting the first one or more candidate responses; and in response to each of the second one or more candidate responses having the corresponding composite response score lower than the threshold value, rejecting the second one or more candidate responses. In an example, the second one or more candidate responses include a given candidate response, wherein the set of operations further include: identifying a given condition match score of a plurality of condition match scores associated with the given candidate response, such that the given condition match score is less than a threshold value, the given condition match score associated with a given condition; and facilitating in generation of a rejection note in support of rejecting the given candidate response, the rejection note including text from the given condition. In an example, the job initiation request includes a job description for an open job position, and wherein the candidate response is a resume and/or a series of answers received in response to the job initiation request.

In various embodiments, a computer-implemented method for automated evaluation of candidate responses to a natural-language job initiation request comprises receiving, via an input interface, a natural-language job initiation request; processing the job initiation request using one or more language models to: (i) detect a set of conditions from the job initiation request, and (ii) assign, for each of the set of conditions, a corresponding relevance score; accessing a plurality of candidate responses to the request; for each condition within the set of conditions and for each candidate response of the plurality of candidate responses: (i) generating a forward-match metric that estimates an extent to which content in the response matches the condition, (ii) generating a reverse-match metric that estimates an extent to which the condition matches the content in the response, and (iii) generating a condition match score based on the forward-match metric and the reverse-match metric; for each candidate response of the plurality of candidate responses, assigning a corresponding composite response score to the candidate response, based at least in part on the condition match scores associated with the candidate response; selecting first one or more candidate responses of the plurality of candidate responses, and rejecting second one or more candidate responses of the plurality of candidate responses, based at least in part on the corresponding composite response scores; and causing presentation of at least one of the selected first one or more candidate responses. In an example, generating the condition match score comprises: for each condition within the set of conditions and for each candidate response of the plurality of candidate responses, generating the condition match score to be a lower one of the forward-match metric and the reverse-match metric. In an example, assigning the composite response score to a given candidate response comprises: assigning the composite response score to the given candidate response by aggregating: (i) a first weighted product of (a) a first relevance score assigned to a first condition and (b) a first condition match score assigned to the given candidate response and for the first condition; and (ii) a second weighted product of (a) a second relevance score assigned to a second condition and (b) a second condition match score assigned to the given candidate response and for the second condition.

In various embodiments, a system comprises: one or more processors; and one or more non-transitory computer-readable media storing instructions, which, when executed by the system, cause the system to perform a set of actions including: receiving, via an input interface, a natural-language job initiation request; transforming, by a computing system, the natural-language job initiation request into a structured data representation using a trained language model, wherein the structured data representation includes: (i) a first set of conditions associated with a first classification category, and (ii) a second set of conditions associated with a second classification category, wherein a first category score and a second category score are assigned to the first classification category and the second classification category, respectively; determining, for each condition in the first and second sets, a corresponding relevance score based at least in part on semantic alignment between the condition and a contextual representation of the job initiation request, the contextual representation generated using a trained embedding model; accessing, by the computing system, textual content of a candidate response to the job initiation request; for each condition, calculating a condition match score between the textual content of the candidate response and the condition using at least a vector similarity function; computing a composite response score for the candidate response by aggregating, for each classification category, a weighted combination of: the relevance scores associated with conditions in the classification category, the corresponding condition match scores, and the category score; generating, based on the composite response score, a ranked list of candidate responses; and causing presentation of at least a portion of the ranked list on a display associated with the computing system. In an example, the set of actions further include: selecting first one or more candidate responses from the ranked list of candidate responses for a subsequent stage of a hiring process associated with the job initiation request; and rejecting second one or more candidate responses from the ranked list of candidate responses for the subsequent stage of the hiring process associated with the job initiation request, wherein at least one of the selected first one or more candidate responses has a higher composite response score than at least one of the rejected second one or more candidate responses.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a response matching and ranking service configured to match a plurality of responses to a job initiation request, and score and rank the plurality of responses in view of the job initiation request.

FIG. 2 illustrates operations of a job condition identification and scoring service of a response matching and ranking service, wherein the job condition identification and scoring service identifies a plurality of job conditions associated with a job initiation request.

FIG. 3 illustrates a condition space for a job initiation request.

FIG. 4A illustrates pseudocode for convergence condition for iterative determination of a condition space from a job initiation request.

FIG. 4B illustrates convergence condition for iterative determination of a condition space from a job initiation request.

FIG. 5 illustrates a plurality of relevance scores assigned to a corresponding plurality of conditions associated with a job initiation request.

FIG. 6A illustrates generation of, for each condition of a plurality of conditions and for each response of a plurality of responses, a corresponding condition match score indicative of a strength of match between textual content of the corresponding response and the corresponding condition.

FIG. 6B illustrates generation of an example condition match score indicative of a strength of match between textual content of a corresponding response and a corresponding condition.

FIG. 7 illustrates a plurality of condition match scores assigned to a plurality of (condition, response) pairs.

FIG. 8 illustrates calculation of two example condition match scores for two example (condition, response) pairs.

FIGS. 9A and 9B illustrate calculation of a composite response score for an example response and for a specific job initiation request.

FIG. 10 illustrates various category scores, various relevance scores, and various condition match scores associated with an example response and for an example job initiation request.

FIG. 11 illustrates ranking of responses, based on their corresponding composite response scores.

FIG. 12 illustrates selection and/or rejection of responses, based on a ranking of the responses for a job initiation request.

FIG. 13 illustrates a flow chart depicting a method for automated matching, scoring, and ranking of responses, and selecting or rejecting individual responses for a job initiation request.

FIG. 14 depicts a simplified diagram of a distributed system for implementing certain aspects.

FIG. 15 is a simplified block diagram of one or more components of a system environment by which services provided by one or more components of an embodiment system may be offered as cloud services, in accordance with certain aspects.

FIG. 16 illustrates an example computer system that may be used to implement certain aspects.

### DETAILED DESCRIPTION

As described above, in response to a job posting, responses are received from prospective candidates applying for a corresponding job position. Currently available automated systems extract entities (such as degrees, skills, experiences, etc.) from a response, find similarity between such extracted entities and the job description, and assign a score to a response. The response is either selected or rejected, based on the score. However, a job description may have a plurality of conditions (such as requirements and responsibilities) associated with the job position, and such currently available systems do not take into account relevance and/or importance of such conditions to the job position, while assigning the score to the response.

Techniques are described herein for automated matching, scoring, and ranking of responses from candidates for a job position, and selecting or rejecting individual responses, while taking into account relevance and/or importance of various conditions (such as requirements and responsibilities) associated with the job position.

For example, a job initiation request comprises a job posting for a job position, and may include a job description, job conditions (such as job requirements and/or responsibilities), information about the organization in which the job is available, and/or one or more other pertinent information about the open job position. The job initiation request is in a natural language, such as English, or another natural language (such as Germany or French). The job initiation request may be generated by the organization having the job opening and/or a contractor (such as a resume posting and/or hiring process management website) hired by the organization.

A plurality of responses from prospective candidates for job posting are received. A response from a candidate may be, in one example, in the form of a resume. In another example, the response may be in the form of answers to questions being asked, a curriculum vitae (CV), an essay, a cover letter submitted in response to the job initiation request, and/or any other relevant information or responses submitted by a prospective candidate in response to the job initiation request. While resumes are described in this disclosure as examples of responses to the job initiation request, the teaching of this disclosure also applies to other forms of responses to the job initiation request. A response from a candidate summarizes qualifications, career objectives, personal and professional interests, professional affiliations, education, history of employment, and/or other relevant information that the candidate believes are relevant for the job position. A job opening may receive multiple such responses.

A response matching and ranking service receives a plurality of responses from a corresponding plurality of candidates applying for the job opening associated with the job initiation request. Prior to processing the responses, the response matching and ranking service analyzes the job initiation request, e.g., to extract (e.g., using a trained language model) a plurality of job conditions. For example, the language model extracts job conditions from the job description within the job initiation request, and each condition is assigned to one of a plurality of condition classification category.

For example, a condition space (e.g., including all conditions extracted from the job initiation request) may include a first condition classification category “Cm” including conditions or requirements that are mentioned within the job initiation request as being mandatory, essential, or must-have for the job position. The condition space may further include condition classification category “Cp” including conditions or requirements that are mentioned within the job initiation request as being preferred for the job position. The condition space may further include condition classification category “Cs” including conditions or requirements that are mentioned within the job initiation request as being soft skills for the job position. The condition space may further include condition classification category “Cr” including job responsibilities that are mentioned within the job initiation request for the job position. Although four example condition classification categories Cm, Cp, Cs, and Cr are described, other appropriate number of such condition classification categories may also be envisioned. Thus, when the language model extracts a condition from the job initiation request, the condition is assigned to one of the condition classification categories Cm, Cp, Cs, and Cr, e.g., based on a nature of the extracted condition. Each condition classification category has a corresponding set of conditions for the job initiation request. In an example, the conditions are extracted and iteratively updated to avoid duplication between any two conditions, as described below in further detail.

In an example, each condition classification category is preassigned a corresponding category score. For example, the condition classification categories Cm, Cp, Cs, and Cr are pre-assigned category scores C1, C2, C3, and C4, respectively. Each of the category scores C1, C2, C3, and C4 represent a relative importance or relevance of the corresponding condition classification category to the job initiation request. As an example, a category score C1 assigned to the condition classification category Cm may be higher than a category score C2 assigned to the condition classification category Cp. Category scores are described below in further detail.

Once the conditions within the various condition classification categories Cm, Cp, Cs, Cr are determined, each condition is assigned a corresponding relevance score, e.g., based at least in part on a semantic alignment between the condition and a contextual representation of the job initiation request, a criticality of the condition, a market demand of a requirement specified within the condition, and/or one or more other relevant factors (such as availability of prospective candidates meeting the condition), as will be described below in further detail.

In an example, the response matching and ranking service assigns, to each pair of condition and response, a corresponding condition match score. Thus, for each response received in response to the job initiation request and for each condition extracted from the job initiation request, a condition match score for the (condition, response) pair is assigned. A condition match score assigned to a given response and for a given condition is indicative of the extent of matching between the given condition and the given response. For example, evidence (which may be a text portion) within the given response, which supports the given condition, is extracted (e.g., by a trained language model). Subsequently, a bidirectional matching between the evidence and the condition is determined, to evaluate a strength of match of the evidence with respect to the condition. The condition match score is assigned based on the bidirectional matching, as will be described below in further detail.

Given (i) the relevance scores for various conditions within various condition classification categories, (ii) the condition match scores for various (condition, response) pairs, and (iii) the category scores for various condition classification categories, a composite response score for each response is calculated. For example, for a given response, the corresponding composite response score is a weighted combination of various associated scores. Calculation of the composite response scores are described below in further detail. In an example, the composite response scores may be normalized.

In an example, the responses are ranked based on the composite response scores (or the normalized composite response scores). Individual responses are selected or rejected, based on the ranked responses, e.g., as described below in further detail. In an example, a rejection explanation for a rejected response may be generated, e.g., based on one or more relatively low condition match scores received by the response, as also described below in further detail.

A technical challenge addressed by some embodiments of the invention relates to automating the transformation of unstructured, natural-language job initiation requests into structured, semantically rich data representations that can be processed reliably at scale. Traditional systems either require manual curation of job request criteria or rely on brittle keyword-based approaches that fail to capture the nuanced semantic relationships and intent behind a user's input. Even with access to computational tools, a human attempting to manually parse, classify, and score conditions across multiple contextual dimensions would face severe limitations in speed, consistency, and scalability-especially when dealing with diverse linguistic expressions and high-volume data streams.

A technical solution provided by some embodiments includes techniques that leverage trained language and embedding models to create structured data representations from free-form input, semantically evaluate response candidates, and compute relevance-aware, category-specific response scores using vector similarity techniques. Importantly, this approach integrates multiple model-driven layers of abstraction: first to identify and classify contextual elements from natural language, and then to quantitatively assess how well candidate responses align with those identified conditions. The structured, multi-stage aggregation of relevance, match, and category scores-executed through learned representations and similarity functions-constitutes a deeply technical mechanism that cannot be replicated by human judgment or conventional rule-based logic alone.

This approach provides a technical advantage of dynamically interpreting and operationalizing subjective user input through generalized, model-based reasoning that is both adaptable and scalable. Unlike human operators, some disclosed techniques are configured to apply high-dimensional semantic analysis and optimization strategies to prioritize response candidates (e.g., in real time). This results in materially improved accuracy, consistency, and processing throughput in response selection-benefits that are achievable through computational intelligence architectures and/or usage of AI tools. Numerous example and embodiments are now described below.

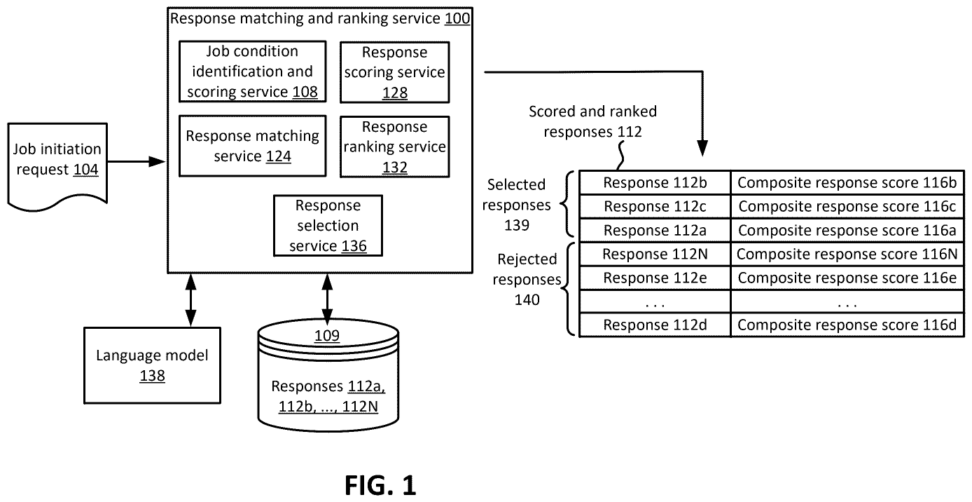

FIG. 1 illustrates a response matching and ranking service 100 configured to match a plurality of responses 112a, . . . , 112b, 112N to a job initiation request 104, and score and rank the plurality of responses 112a, . . . , 112b, 112N in view of the job initiation request 104. The response matching and ranking service 100 may be operated for an organization, such as a human resource (HR) department of the organization, which hires personnel for one or more job openings. The response matching and ranking service 100 may facilitate response screening, scoring, and/or ranking process for such one or more job openings.

The job initiation request 104 comprises a job posting for a job position, and may include a job description, job conditions (such as job requirements and/or responsibilities), information about the organization in which the job is available, and/or one or more other pertinent information about the open job position. In an example, the job initiation request 104 is in a natural language, such as English, or another natural language (such as Germany or French). The job initiation request 104 may be generated by the organization (or a contractor hired by the organization) having the job opening.

The plurality of responses 112a, . . . , 112N may be received from a corresponding plurality of candidates applying for the job opening associated with the job initiation request 104. Each response 112 may be from a prospective candidate applying for the job opening. For example, a candidate applies for the job opening, by submitting a corresponding response 112. In an example, the responses 112a, . . . , 112N are stored within a storage repository 109, and the response matching and ranking service 100 accesses the storage repository 109 storing the plurality of responses 112a, 112b, . . . , 112N. The responses 112a, . . . , 112N are received in response to the job initiation request 104.

A response from a candidate may be, in one example, in the form of a resume, in which case the response matching and ranking service 100 analyzes the resume, as described herein. In another example, the response may be in the form of answers to questions being asked, and in such a case, the response matching and ranking service 100 may analyze the answers to the questions. Thus, while resumes are described herein as examples of responses to the job initiation request 104, the teachings of this disclosure also applies to other forms of responses to the job initiation request 104, such as answers to questions, curriculum vitae (CVs), essays and/or cover letters submitted in response to the job initiation request 104, and/or any other relevant information or responses submitted by prospective candidates in response to the job initiation request 104.

Whenever prospective candidates submit responses to the job initiation request 104, the response matching and ranking service 100 may analyze such responses. As will be described below in further detail, the response matching and ranking service 100 assigns composite response scores 116a, . . . , 116N respectively to the responses 112a, . . . , 112N, e.g., based on a suitability of each response 112 for the corresponding job initiation request 104. In an example, the response matching and ranking service 100 ranks the responses 112a, . . . , 112N based on the corresponding composite response scores 116a, . . . , 116N. Merely as an example and as illustrated in FIG. 1, the response matching and ranking service 100 ranks the response 112b having the composite response score 116b at a number one position, followed by response 112c having the composite response score 116c, followed by response 112a having the composite response score 116a, and so on, as will be described below in further detail.

As will also be described below in further detail, the response matching and ranking service 100 may screen responses based on the ranking of the responses 112. For example, the response matching and ranking service 100 selects or approves one or more better ranked responses (e.g., responses 112b, 1112c, 112a) for a next stage of the hiring process, while rejecting one or more lower ranked responses (e.g., responses 112N, 112e, 112d) for the job opening. The response matching, scoring, and ranking operations are described below in further detail.

In an example, the response matching and ranking service 100 comprises a job condition identification and scoring service 108, a response matching service 124, a response scoring service 128, a response ranking service 132, a response selection service 136, and may communicate with one or more language models 138, each of which are described below in further detail.

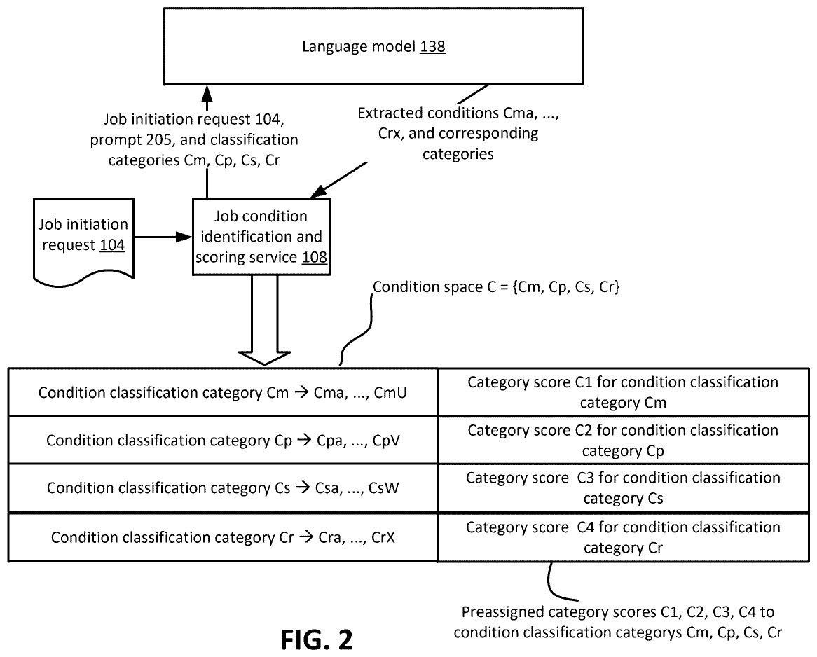

FIG. 2 illustrates operations of a job condition identification and scoring service 108 of a response matching and ranking service 100, wherein the job condition identification and scoring service 108 identifies a plurality of job conditions associated with a job initiation request 104. As illustrated in FIG. 2, the job condition identification and scoring service 108 receives the job initiation request 104 (which is in a natural language, such as English). In an example, the job condition identification and scoring service 108 facilitate in identification a canonical kernel of a plurality of conditions of the job initiation request 104. The job condition identification and scoring service 108 communicates with a language model 138, which identifies a plurality of conditions for the job opening. In an example, job condition identification and scoring service 108 communicates with the language model 138 via an application programming interface (API).

In an example, the language model 138 is a pretrained large language model (LLM). In another example, the language model 138 is a pretrained small language model (SLM).

Note that although a single language model 138 is illustrated to perform various described processes herein, the single language model 138 may be replaced by a plurality of language models and/or embedding models. In an example, the language model 138 may comprise a single LLM. In another example, the language model 138 may comprise a plurality of SLMs. In yet another example, the language model 138 may be replaced by an embedding model. The language model 138 is described below to perform various tasks. However, a first language model may be trained to perform first one or more tasks, a second language model may be trained to perform second one or more tasks, an embedding model may be trained to perform third one or more tasks, and so on. All such machine learning model(s) that may be used to perform one or more tasks described herein are generically represented as the language model 138.

In an example, the job condition identification and scoring service 108 receives the job initiation request 104, and transmits the job initiation request 104 and one or more classification categories (such as classification categories Cm, Cp, Cs, Cr) to the language model 138, along with a prompt 205 to identify and extract conditions from the job initiation request 104.

In an example, the job condition identification and scoring service 108 generates or otherwise accesses a condition space C comprising a plurality of classification categories Cm, Cp, Cs, Cr, where C is a set of conditions (such as job requirements and/or job responsibilities) associated with the job initiation request 104. For example, the language model 138 parses the job initiation request 104, to identify and extract the condition space C associated with the job initiation request 104. Note that the conditions are essentially requirements and responsibilities for the job opening, and hence, the condition space C is also referred to herein as a requirement space, and the conditions for the job opening are also referred to as requirements for the job openings.

The condition space C associated with the job initiation request 104, in an example, includes the plurality of condition classification categories Cm, Cp, Cs, Cr. Merely as an example, the condition space C comprises a first condition classification category including conditions or requirements that are mentioned within the job initiation request 104 as being essential or must-have for the job position. Hence, the first classification category is referred to as a mandatory (or essential, or must have) condition classification category Cm (or simply as condition classification category Cm). For example, the job description within the job initiation request 104 may include phrases like “the candidate must have an advance degree in Computer Science,” or “the candidate has to have an advance degree in Computer Science,” and such a condition is categorized by the language model 138 within the condition classification category Cm. For example, while parsing the job initiation request 104, if the language model 138 identifies (e.g., within the job initiation request 104) a condition that is deemed to be mandatory (or essential, or must have) condition for the job position, the language model 204 classifies the condition within the classification category Cm.

In an example, the condition space C associated with the job initiation request 104 comprises a second condition classification category including conditions or requirements that are mentioned within the job initiation request 104 as being preferred for the job position. Hence, the second classification category is referred to as a preferred (or nice-to-have) condition classification category Cp (or simply as condition classification category Cp). For example, the job description within the job initiation request 104 may include phrases like “it's a plus to have an MBA degree,” or “the candidate is preferred to have an MBA degree,” and such a condition is categorized within the condition classification category Cp. For example, while parsing the job initiation request 104, if the language model 138 identifies (e.g., within the job initiation request 104) a condition that is deemed to be a preferred condition for the job position, the language model 204 classifies the condition within the classification category Cp.

In an example, the condition space C associated with the job initiation request 104 comprises a third condition classification category including conditions or requirements that are mentioned within the job initiation request 104 as being soft skills for the job position. Hence, the third classification category is referred to as a soft skills condition classification category Cs (or simply as condition classification category Cs). For example, the job description within the job initiation request 104 may include phrases like “the ideal candidate should have good communication skills and should be a group player,” and such a condition is categorized within the condition classification category Cs. For example, while parsing the job initiation request 104, if the language model 138 identifies (e.g., within the job initiation request 104) a condition that is deemed to be a soft-skill condition for the job position, the language model 204 classifies the condition within the classification category Cs.

In an example, the condition space C associated with the job initiation request 104 comprises a fourth condition classification category including conditions or responsibilities that are mentioned within the job initiation request 104 as being responsibilities for the job position. Hence, the fourth classification category is referred to as a responsibility condition classification category Cr (or simply as condition classification category Cr). For example, the job description within the job initiation request 104 may include phrases like “the ideal candidate is expected to lead a team of 20 engineers,” and such a condition is categorized within the condition classification category Cr. For example, while parsing the job initiation request 104, if the language model 138 identifies (e.g., within the job initiation request 104) a condition that is deemed to be a responsibility of the person to be employed for the job position, the language model 204 classifies the condition within the classification category Cr.

In an example, the pretrained language model 138 identifies various conditions C(which may be included within any of the plurality of condition classification categories described above) associated with the job initiation request 104. For example, the language model 138 receives the natural language job initiation request 104 and indication of the various condition classification categories, along with the prompt 205 to identify conditions within the job initiation request 104, and assign each identified condition to a corresponding condition classification category, as illustrated in FIG. 2.

The language model 138 parses the job description associated with job initiation request 104, and identifies or extracts the various conditions C. For example, the language model 138 (i) identifies one or more conditions Cma, . . . , CmU and assigns those to the condition classification category Cm, (ii) identifies one or more conditions Cpa, . . . , CpV and assigns those to the condition classification category Cp, (iii) identifies one or more conditions Csa, . . . , CsW and assigns those to the condition classification category Cs, and (iv) identifies one or more conditions Cra, . . . , CrX and assigns those to the condition classification category Cp, as illustrated in FIG. 2. Here, each of U, V, W, and X is a positive integer and at least one. Two or more of the integers U, V, W, and X may be same to each other, or may be different from each other. The language model 138 transmits the extracted conditions Cma, . . . , Crx and corresponding classification categories to the job condition identification and scoring service 108.

Note that although four condition classification categories are described herein, in another example and contrary to FIG. 2, there may be less (or more) than such four condition classification categories. For example, there may be a single condition classification category, where each condition is weighed using a corresponding condition score. The four condition classification categories described herein are mere examples, and not intended to limit the scope of this disclosure.

In an example, the conditions within the condition space C={Cm, Cp, Cr, Cs} are generated such that no two conditions within this space overlap with each other. For example, the conditions are orthogonal to each other in a vector space of the condition space C.

In an example, the conditions within the condition space C={Cm, Cp, Cr, Cs} are represented in a structured format, such that the condition space C is a structured data. Merely as an example, the conditions within the condition space C may be represented using JavaScript Object Notation (JSON) format.

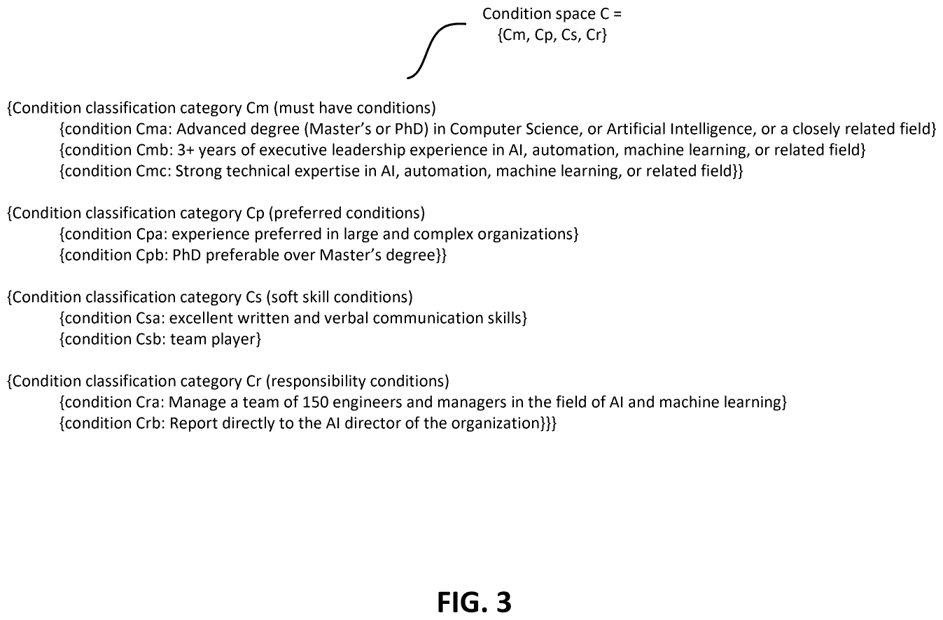

FIG. 3 illustrates an example condition space C={Cm, Cp, Cs, Cr} for a job initiation request 104. The condition space C includes (i) a first plurality of conditions within the condition classification category Cm (e.g., must have conditions), (ii) a second plurality of conditions within the condition classification category Cp (e.g., preferred conditions), (iii) a third plurality of conditions within the condition classification category Cr (e.g., responsibility conditions), and (iv) a fourth plurality of conditions within the condition classification category Cs (e.g., soft skill conditions). Note that a number and a nature of the conditions C illustrated in FIG. 3 are mere examples, and do not limit the scope of this disclosure. The conditions C illustrated in FIG. 3, merely as examples, may be for a leadership role in the field of artificial intelligence (AI) or machine learning (ML) field of a large organization, and are self-explanatory. As described above, the conditions C of FIG. 3 comprises structured data, and may be generated by the language model 138 and the job condition identification and scoring service 108, based on the language model 138 parsing the job description within the job initiation request 104.

For purposes of this disclosure, “c” denotes a specific condition within the condition space C. Thus, a condition c can belong to any of the condition classification categories Cm, Cp, Cr, or Cs.

For purposes of this disclosure, “cm” denotes a specific condition within the condition classification category Cm, “cp” denotes a specific condition within the condition classification category Cp, “cs” denotes a specific condition within the condition classification category Cs, and “cr” denotes a specific condition within the condition classification category Cr.

As described above, the conditions C are identified by the language model 138 such that no two conditions overlap with each other. For example, for any two conditions c1 and c2 within spaces Ci and Cj, where i≠j (e.g., Ci and Cj can be any two dissimilar condition classification categories), there cannot be any overlap between c1 and c2. Thus:

For arbitrary conditions c1 and c2 within spaces Ci and Cj, where i≠j, overlap (c1, c2)=0. Equation 1

Thus, the language model 138 and the job condition identification and scoring service 108 aims to avoid duplication of the conditions within the condition space C. For example, the condition space C includes conditions Cma, . . . , CmU, Cpa, . . . , CpV, Csa, . . . , CsW, Cra, . . . , CrX, and the language model 138 aims to extract these conditions from the job initiation request 104 such that these conditions are unique and not duplicative of each other. In an example, the language model 138 iteratively extracts the condition space C, and compares the condition sets between two iterations. The language model 138 looks for convergence of the condition space C between consecutive iterations. If difference between the condition spaces C(p) and C(p+1) associated with the pth and (p+1)th iterations, respectively, is less than a threshold (e.g., the two sets of condition spaces converge), then the process of detecting the condition space is complete. Otherwise, the process of finding the condition space C is iteratively repeated, e.g., until a pre-specified maximum number of iterations have been completed.

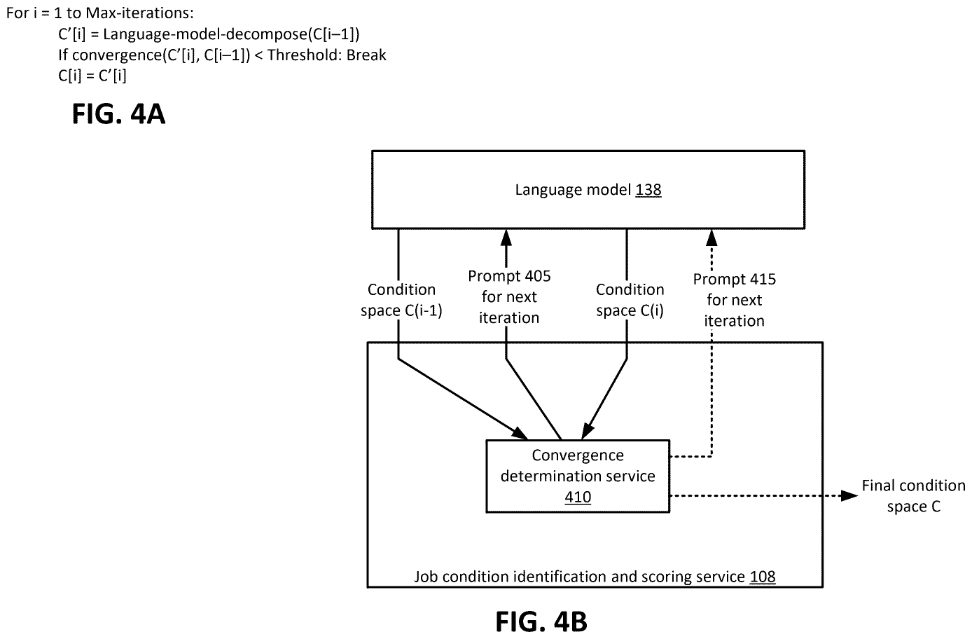

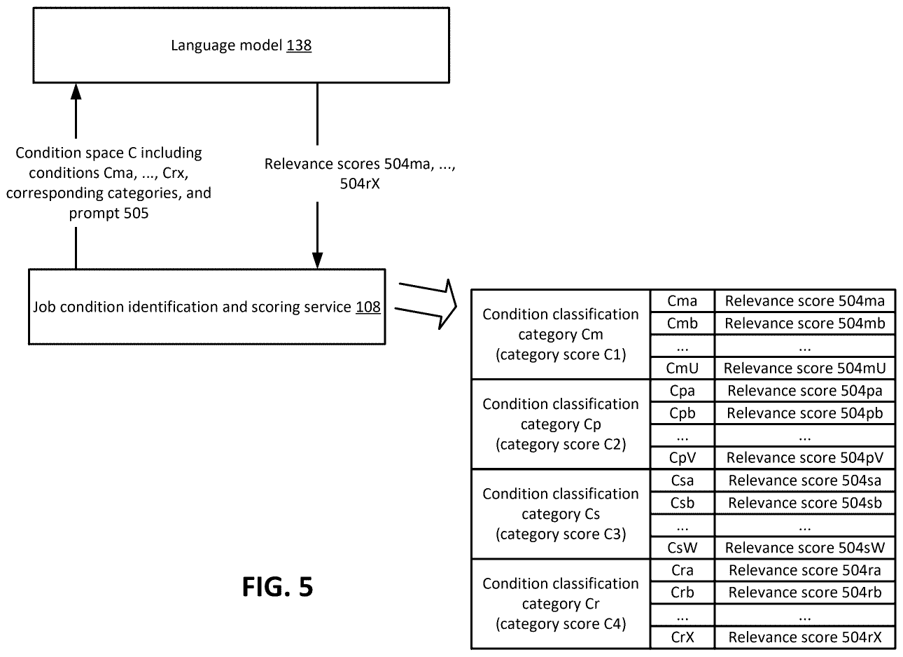

For example, FIG. 4A illustrates pseudocode for convergence condition for iterative determination of a condition space from a job initiation request 104. In FIG. 4A, the Language-model-decompose (C [i]) determines, at iteration (i), the condition space C by decomposing the job initiation request 104 by the language model 138. If the difference between condition spaces of two consecutive iterations is less than a threshold, convergence is assumed, and the loop ends. Until the iterative generation and refinement of the condition space C is repeated, until a pre-specified maximum number of (or threshold number of) iterations has reached.

FIG. 4B illustrates determination of convergence condition for iterative determination of a condition space from a job initiation request 104. For example, the job condition identification and scoring service 108 includes a convergence determination service 410. At an (i−1)^{th} iteration, the convergence determination service 410 receives a condition space C(i−1). The convergence determination service 410 facilitates in transmission of a prompt 405 to generate a next condition space. At a next i^{th} iteration, the language model 138 generates condition space C(i), e.g., by refining the condition space C(i−1) and/or by parsing the job initiation request 104. The convergence determination service 410 compares the condition spaces C(i) and C(i−1). If a difference condition spaces C(i) and C(i−1) is less than a threshold value (or if a maximum number of iterations have been performed), then the convergence determination service 410 stops further iteration, and the job condition identification and scoring service 108 outputs the final condition space C(which may be the condition space C(i)), illustrated as dotted line in FIG. 4B as a first option. However, if the difference condition spaces C(i) and C(i−1) is more than the threshold value and if the maximum number of iterations has not been performed, the convergence determination service 410 facilitates in transmission of a prompt 415 for next iteration and generation of a further condition space C(i+1) to the language model 138, and this process iteratively continues, as illustrated in dotted line as a second option in FIG. 4B.

Referring again to FIG. 2, the condition classification categories Cm, Cp, Cs, and Cr are pre-assigned category scores C1, C2, C3, and C4, respectively. For example, category score C1 is assigned to condition classification category Cm, category score C2 is assigned to condition classification category Cp, category score C3 is assigned to condition classification category Cs, and category score C4 is assigned to condition classification category Cr. Each of the category scores C1, C2, C3, and C4 represent an importance of the corresponding condition classification category to the job initiation request 104.

For example, as would be appreciated, a “must have” condition within the condition classification category Cm may be perceived by the organization to be relatively more relevant or important to the job opening, than each of a “preferred” condition within the condition classification category Cp or a “soft skill” condition within the condition classification Cs, or a “responsibility” condition Cr within the condition classification category Cr. Accordingly, in an example, the category score C1 for condition classification category Cm may be higher than the category scores C2, C3, and/or C4. Merely as an example, the category scores C1, C2, C3, and C4 may be 1.0, 0.5, 0.25, and 0.25, respectively, although other values may also be possible.

In an example, the category scores C1, C2, C3, and C4 may be preassigned (e.g., by an operator of the response matching and ranking service 100, or by a ML model), and may be common for a plurality of job initiation requests (such as the job initiation request 104 and for other job initiation requests). Thus, the category scores C1, C2, C3, and C4 may not change with each job initiation request processed by the response matching and ranking service 100. In an example, the category scores C1, C2, C3, and C4 may comprise performance-based historical weightings for classification categories, which may be fine-tuned at periodic or aperiodic intervales, e.g., based on historic operation of the response matching and ranking service 100. Thus, the category scores C1, C2, C3, and C4 are preassigned to the response matching and ranking service 100, and may be independent of the job initiation request 104.

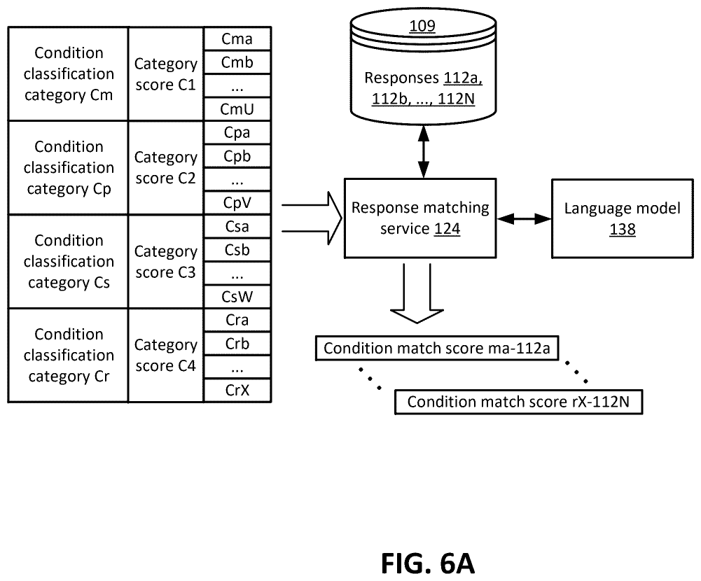

Once the conditions C within the various condition classification categories Cm, Cp, Cs, Cr are determined, each condition is assigned a corresponding relevance score 504. FIG. 5 illustrates a plurality of relevance scores assigned to a corresponding plurality of conditions associated with a job initiation request 104. For example, the job condition identification and scoring service 108 transmits to the language model 138 the condition space C including conditions Cma, . . . , Crx, corresponding condition classification categories, and a prompt 505 to assign relevance scores to each condition. The language model 138 assigns a corresponding relevance score to each condition within the condition space C. As illustrated in FIG. 5, the job condition identification and scoring service 108 assigns relevance scores 504ma, 504mb, . . . , 504mU to the conditions Cma, Cmb, . . . , CmU of the condition classification category Cm, as illustrated in FIG. 5. Other conditions of the other condition classification categories are also similarly assigned corresponding relevance scores, as illustrated in FIG. 5.

A relevance score 504 assigned to a condition c as follows:

Relevance score(c)=function of (context,criticality,market demand, and/or other relevant factors of the condition c with respect to the job initiation request 104). Equation 2.

For example, each condition in various condition classification categories is assigned a corresponding relevance score, e.g., based at least in part on semantic alignment between the condition and a contextual representation of the job initiation request 104, a criticality of the condition, a market demand of a requirement specified within the condition, and/or one or more other relevant factors (such as availability of prospective candidates meeting the condition).

The language model 138 is pretrained to assign the relevance scores to each condition within the condition space C. For example, the language model 138 estimates a semantic alignment between the condition and a contextual representation of the job initiation request 104. In an example, a trained embedding model may be use as a language model 138, when estimating the semantic alignment.

For example, function(context) determines a context of the condition c with respect to the job requirements of the specific job initiation request 104. Similarly, function(criticality) determines a criticality of the condition c with respect to the job requirements of the specific job initiation request 104. Similarly, function(market_demand) determines a market demand of a condition. Thus, a relevance score 504 is generated by the language model 138 for a condition, e.g., based on a relevance of the condition with respect to the job initiation request 104 and/or other factors described above.

For example, for a job initiation request 104 for a leadership or managerial role position in an organization within the technical sector, an MBA (Master of Business Administration) may be more relevant than a PhD in Computer Science, although the job posting may say that an MBA and/or a PhD may be preferred. For such a job initiation request 104, a condition associated with an MBA degree may have a higher relevance score than a condition associated with a PhD in computer science.

However, for another job initiation request for a coding or technical lead position in an organization within the technical sector, a PhD may be more relevant than an MBA in computer science. For such a job initiation request, a condition associated with a PhD may have a higher relevance score than a condition associated with an MBA.

In yet another example, for yet another job initiation request for a coding position in an organization within the technical sector, a Master of Computer Science may be more relevant than a Master of Electrical Engineering, although the job posting may require a graduate degree in Computer Science, or Electrical Engineering, or a closely related field. For such a job initiation request, a condition associated with a Master of Computer Science may have a higher relevance score than a condition associated with a Master of Electrical Engineering.

As also described, function(market_demand) determines a market demand of a condition. For example, assume that the job initiation request 104 indicates that a PhD in Artificial Intelligence (AI) is preferred for the job. Also, the market demand for a PhD in AI may be very high, as supply of PhDs in AI may be low. Accordingly, a relatively high relevance score may be assigned to a condition associated with a PhD in AI, such that a response of a prospective candidate having such a degree is ranked higher in a ranking of all responses received for the job initiation request.

Thus, a relevance score 504 is generated by the language model 138 for a condition, e.g., based on the language model 138 analyzing the condition with respect to the job initiation request 104 and/or one or more external factors (such as market demand).

In an example, each of the relevance scores for various conditions is bounded by an upper limit relevance_upper and a lower limit relevance_lower. Merely as an example, a relevance score 504 may range between 0 (e.g., relevance_lower) and 10 (relevance_upper).

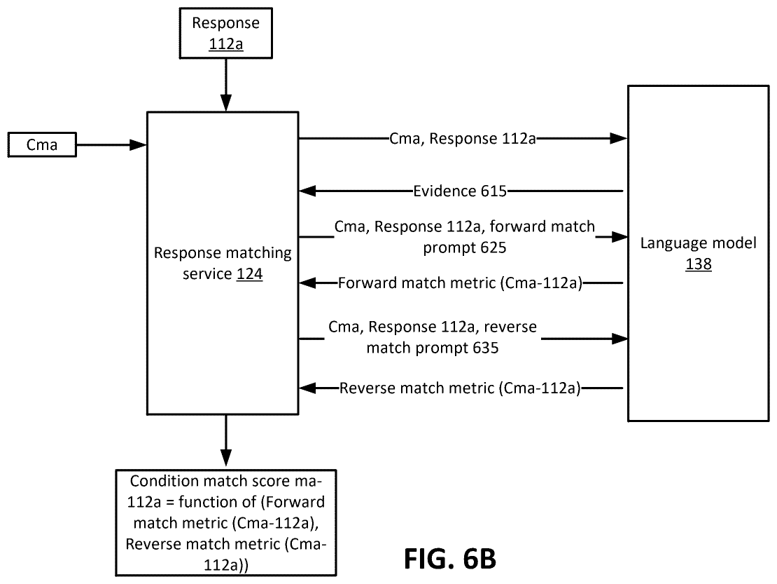

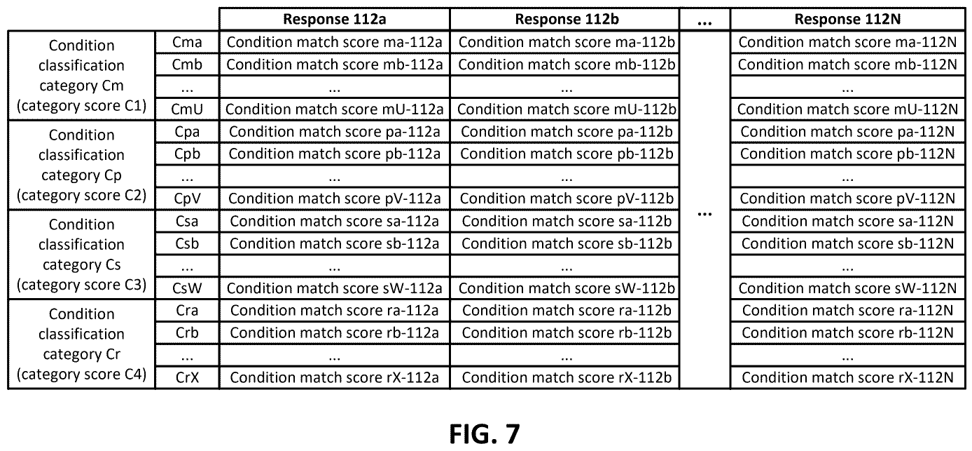

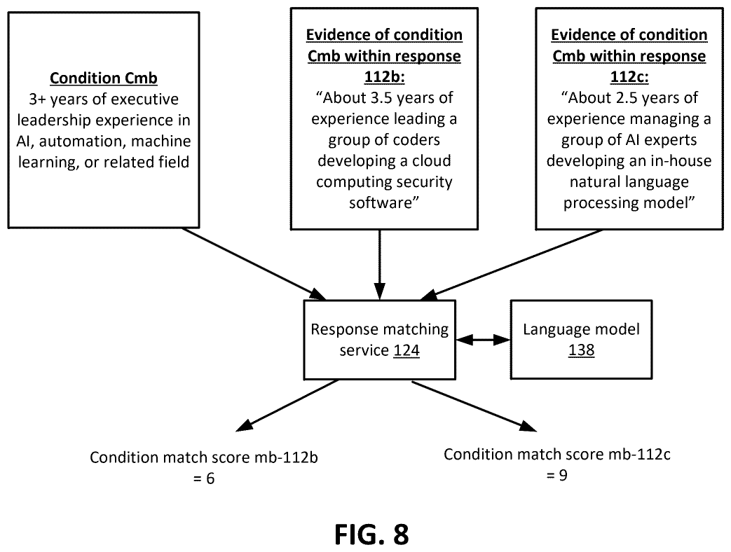

FIG. 6A illustrates generation of, for each condition of a plurality of conditions Cma, . . . , CmU, Cpa, . . . , CpV, Csa, . . . , CsW, Cra, . . . , CrX and for each response of a plurality of responses 112a, . . . , 112N, a corresponding condition match score indicative of a strength of match between textual content of the corresponding response and the corresponding condition. FIG. 6B illustrates generation of an example condition match score (Cma-112a) indicative of a strength of match between textual content of a corresponding response 112a and a corresponding condition Cma. FIG. 7 illustrates a plurality of condition match scores assigned to a plurality of (condition, response) pairs.

Referring to FIGS. 6A and 7, conditions Cma, . . . , CmU, Cpa, . . . , CpV, Csa, . . . , CsW, Cra, . . . , CrX for various condition classification categories Cm, Cp, Cs, Cr are extracted by the language model 138, as described above with respect to FIGS. 2-5. The response matching service 124 then prompts the language model 138 to compare each condition to each response, to generate an extent of matching between a pair of a condition and a response. The response matching service 124 then assigns a condition match score to the (condition, response) pair. In an example, the response matching service 124 communicates with, or acts as an interface (such as an application programming interface or API) with the language model 138. The language model 138 detects a strength of match between each of a plurality of (condition, response) pairs, based on which the response matching service 124 assigns a corresponding condition match score to each of the plurality of (condition, response) pairs.

For example, the response matching service 124 and/or the language model 138 of FIG. 6A assigns the plurality of condition match scores of FIG. 7. As an example, based on a strength or extent of match between condition Cma and response 112a, a condition match score ma-112a is assigned to the (condition Cma, response 112a) pair. Similarly, based on a strength or extent of match between condition CrX and response 112N, a condition match score rX-112N is assigned to the (condition CrX, response 112N) pair, as illustrated in FIG. 7.

In an example, each of the condition match scores for various (condition, response) pairs is bounded by an upper limit and a lower limit. Merely as an example, a condition match score may range between 0 and 10, although other examples of such upper and lower limits can be possible.

To calculate a condition match score for a pair (condition c, response 112i) (where i is any of a, . . . , N, and condition c is any condition), a match between the condition c and the response 112i is determined by the language model 138 as follows:

match (response 112i, condition c)=function(semantic similarity between response 112iand condition c, and evidence strength of the semantic similarity). Equation 3

In an example, the function of equation 3 is determined by the language model 138, based on a semantic similarity between the response 112i and the condition c, and a strength of an evidence of the semantic similarity between the response 112i and the condition c.

For example, an evidence of the semantic similarity between response 112i and condition c is determined initially, by the language model 138, which may be represented as follows:

evidence=language_model_extraction (response 112i, condition c). Equation 4

Thus, an evidence of a semantic similarity between response 112i and condition c is extracted from the response 112i. In a first example, if the condition c is associated with an advance degree or graduate degree in Computer Science or related field, and the response 112i has a phrase “PhD in computer Science,” this phrase acts as an evidence of semantic similarity between response 112i and condition c. In a second example, if the condition c is associated with an advance degree or graduate degree in Computer Science or related field, and the response 112i has a phrase “Masters of Electrical Engineering,” this phrase also acts as an evidence of semantic similarity between response 112i and condition c.

Subsequently, a matching strength between the condition c and the evidence from the response 112i is calculated. For example, a forward-match metric is calculated that estimates an extent to which the condition c matches the evidence from the response 112i. Similarly, a reverse-match metric is calculated that estimates an extent to which the evidence from the response 112i matches the condition c. Thus, the forward-match metric and the reverse-match metric for the (response 112i, condition c) pair are calculated using corresponding vector similarity functions, for example, as follows:

forward-match metric(c-112i)=compute_match(condition c,evidence from response 112imatching the condition c). Equation 5

reverse-match metric(c-112i)=compute_match(evidence from response 112imatching the condition c,condition c). Equation 6

Thus, a bidirectional validation of the match between the evidence and the condition are evaluated in equations 5-6, as the matching in two directions may not be symmetric. Subsequently, the condition match score c-112i is calculated as follows:

condition match score c-112i=function(forward-match metric(c-112i),reverse-match metric(c-112i)). Equation 7.

The function of equation 7 can be, for example, an average function, a maximum function, a minimum function, a weighted average function, a sum function, or the like. That is, the final condition match score c-112i of equation 7 may be an average of, or a maximum of, or a minimum of, or a weighted average, or a sum of the forward-match metric (c-112i) of equation 5 and the reverse-match metric (c-112i) of equation 6. In an example, the final condition match score c-112i of equation 7 is a minimum of the forward-match metric (c-112i) of equation 5 and the reverse-match metric (c-112i) of equation 6

For a given response 112i, the condition match score is determined for each condition of a plurality of conditions Cma, . . . , CmU, Cpa, . . . , CpV, Csa, . . . , CsW, Cra, . . . , CrX. The process is then repeated for each response of the plurality of responses 112a, . . . , 112N received for the job initiation request 104. Various example condition match scores are illustrated in FIG. 7.

Now referring to FIG. 6B, illustrated are example communication between the language model 138 and the response matching service 124 to detect a condition match score for an example condition-response pair (Cma-112). The response matching service 124 transmits the condition Cma and the response 112 to the language model 138. The language model 138 extracts, from the response 112a, evidence 615 of a semantic similarity between the response 112a and condition Cma. The response matching service 124 then transmits the condition Cma, the response 112a, and a forward match prompt 625 to the language model 138, to generate a corresponding forward-match metric (Cma-112a). The response matching service 124 receives the corresponding forward-match metric (Cma-112a) from the language model 138, see equation 5. The response matching service 124 then transmits the condition Cma, the response 112a, and a reverse match prompt 635 to the language model 138, to generate a corresponding reverse-match metric (Cma-112a). The response matching service 124 receives the corresponding reverse-match metric (Cma-112a) from the language model 138, see equation 6. The response matching service 124 then generates the condition match score ma-112a to be a function of the forward match metric and the reverse match metric, see equation 7.

In an example, one or more operations illustrated in FIG. 6B may be combined. For example, the prompts 625 and 635 may be combined, to instruct the language model 138 to generate both the forward-match metric and the reverse-match metric. In another example, a single prompt may cause the language model 138 to generate the evidence, the forward-match metric, and the reverse-match metric. Other variations may also be envisioned.

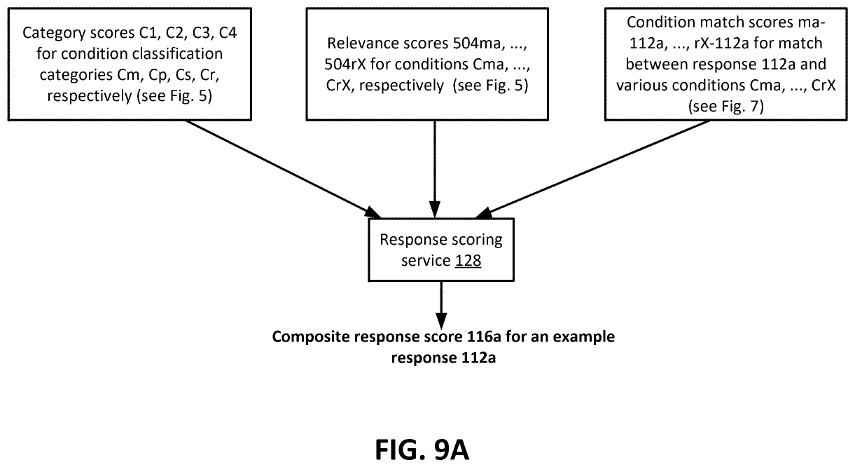

FIG. 8 illustrates calculation of two example condition match scores mb-112b and mb-112c. The condition match score mb-112b is indicative of a strength of a match between the condition Cmb and the response 112b, and the condition match score mb-112c is indicative of a strength of a match between the condition Cmb and the response 112c.

For example, the condition Cmb of the condition classification category Cm in the example of FIG. 8 states the following: “3+years of executive leadership experience in AI, automation, machine learning, or related field.”

The response matching service 124 and the language model 138 extracts evidence of condition Cmb within the response 112b, where the evidence of condition Cmb within the response 112b is as follows: “About 3.5 years of experience leading a group of coders developing a cloud computing security software.” The language model 138 determines a forward-match metric and a reverse-match metric between (i) the evidence of condition Cmb within the response 112b and (ii) the condition Cmb, and assigns a condition match score mb-112b of, for example, 6. Note that a relatively low score of 6 (e.g., compared to the condition match score mb-112c described below) may be because the 3.5 years of experience is for developing a cloud computing security software, and not in the field of AI, automation, machine learning, or related field, as indicated in the condition Cmb.

The response matching service 124 and the language model 138 also extracts evidence of condition Cmb within the response 112c, where the evidence of condition Cmb within the response 112c is as follows: “About 2.5 years of experience managing a group of AI experts developing an in-house natural language processing model.” The language model 138 determines a forward-match metric and a reverse-match metric between (i) the evidence of condition Cmb within the response 112c and (ii) the condition Cmb, and assigns a condition match score mb-112c of, for example, 9. Note that a relatively high score of 9 (e.g., compared to the condition match score mb-112b described above) may be because the 2.5 years of experience is in the field of AI and natural language processing models, which aligns with the field of AI, automation, machine learning, or related field indicated in the condition Cmb. A perfect score of 10 may not be assigned, as the condition Cmb indicates a 3+years of experience, while the evidence of condition Cmb within the response 112c indicates about 2.5 years of relevant experience.

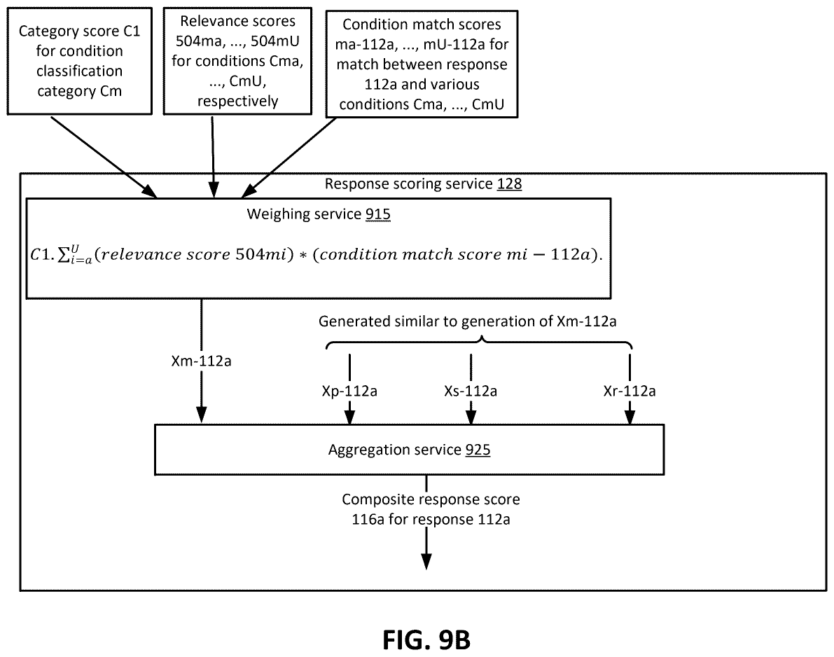

After the relevance scores for various conditions are calculated and the condition match scores for various (condition, response) pairs are calculated (and assuming that category scores for various condition classification categories are assigned), a composite response score for each response is calculated. FIG. 9A illustrates calculation of a composite response score 912a for an example response 112a and for a job initiation request 104. For example, the response scoring service 128 receives category scores C1, C2, C3, C4 for condition classification categories Cm, Cp, Cs, Cr, respectively, see FIG. 5. The response scoring service 128 also receives relevance scores 504ma, . . . , 504rX for conditions Cma, . . . , CrX, respectively, also see FIG. 5. Finally, the response scoring service 128 also receives condition match scores ma-112a, . . . , rX-112a for match between response 112a and various conditions Cma, . . . , CrX, see FIG. 7. Based on a weighted combination of these scores, the response scoring service 128 generates a composite response score 116a for response 112a. The response scoring service 128 repeats this process for other responses 112b, . . . , 112N received for the job initiation request 104, to respectively generates composite response scores 116b, . . . , 116N for responses 112b, . . . , 112N.

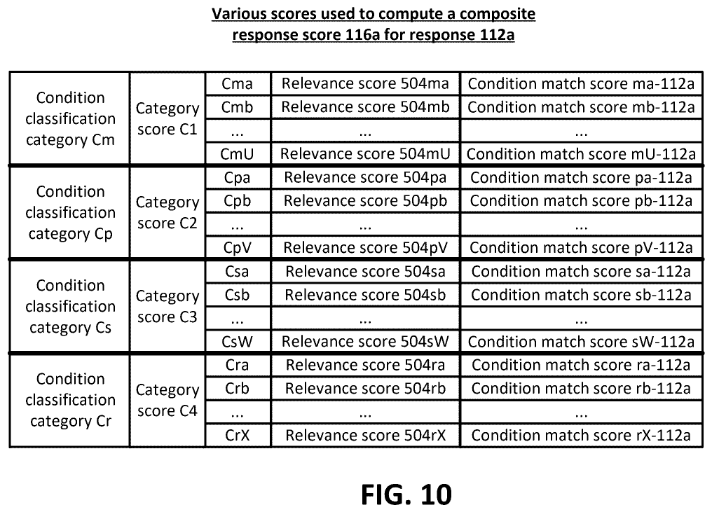

FIG. 10 illustrates various category scores C1, . . . , C4, various relevance scores 504ma, . . . , 504rX, and various condition match scores ma-112a, . . . , rX-112a associated with an example response 112a and for an example job initiation request 104. Referring to FIGS. 9A and 10, in an example, the composite response score 116a assigned to the response 112a is computed as follows:

$$Xm - 112 a = C 1 \cdot {\sum }_{i = a}^{U} ( relevance score 504 mi ) * ( condition match score mi - 112 a ) . \qquad Eq . 8$$

$$Xp - 112 a = C 2 \cdot {\sum }_{i = a}^{V} ( relevance score 504 pi ) * ( condition match score pi - 112 a ) . \qquad Eq . 9$$

$$Xs - 112 a = C 3 \cdot {\sum }_{i = a}^{W} ( relevance score 504 si ) * ( condition match score si - 112 a ) . \qquad Eq . 10$$

$$Xr - 112 a = C 4 \cdot {\sum }_{i = a}^{X} ( relevance score 504 ri ) * ( condition match score ri - 112 a ) . \qquad Eq . 11$$

$$Composite resume score 912 a for resume 112 a = Xm - 112 a + Xp - 112 a + Xs - 112 a + Xr - 112 a . \qquad Eq . 12$$

Equations 8, 9, 10, and 11 illustrate computation of composite classification scores Xm-112a, Xp-112a, Xs-112a, Xr-112a for classification categories Cm, Cp, Cs, and Cr, respectively. In equation 11, these composite classification scores Xm-112a, Xp-112a, Xs-112a, Xr-112a are summed or aggregated, to compute the composite score 912a for response 112a.

Referring to equation 8, the composite classification score Xm-112a is a sum of product of, for each condition within the classification category Cm, (i) the category score C1, (ii) a relevance score of the corresponding condition, and (iii) a condition match score between the corresponding condition and the response 112a. For example, equation 8 is essentially the following:

Xm-112a=C1·(relevance score 504ma)·(condition match score ma-112a)+ . . . +C1·(relevance score 504mU)·(condition match score mU-112a). Eq. 8A

In an example, the product of (i) the category score C1, (ii) the relevance score 504ma, and (iii) the condition match score ma-112a provides an indication of an importance of the classification category Cm to the job initiation request 104, a relevance of the condition Cm to the job initiation request 104, and how well the response 112a matches the condition Cm. Equations 9, 10, and 11 will be apparent, based on the above description with respect to equation 8.

FIG. 9B also illustrates calculation of a composite response score 912a for an example response 112a and for a job initiation request 104. For example, the response scoring service 128 includes a weighing service 915 that receives the category score C1 for condition classification category Cm, the relevance scores 504ma, . . . , 504mU for conditions Cma, . . . , CmU, respectively, and the condition match scores ma-112a, . . . , mU-112a for match between response 112a and various conditions Cma, . . . , CmU. The weighing service 915 determines the composite classification scores Xm-112a, e.g., based on the above-described equations 8a and 8A. The weighing service 915 similarly determines the other composite classification scores Xp-112a, Xs-112a, and Xr-112a, e.g., based on the above-described equations 9-11. Finally, an aggregation service 925 generates the composite response score 116a for the response 112a, e.g., based on the composite classification scores Xm-112a, Xp-112a, Xs-112a, and Xr-112a, as described above with respect to equation 12.

While equations 8, 8A, 9, 10, 11, and 12 and FIGS. 9A, 9B, and 10 discuss computation of the composite response score 116a for the response 112a, this process can be repeated for all the responses 112b, . . . , 112N received for the job initiation request 104.

In an example, the composite scores may be normalized, e.g., by dividing the composite scores by a maximum possible composite score and then computing a corresponding percentage. Thus, if a maximum possible composite score is max_composite_score, then a normalized composite score for response 112a may be computed as follows:

$$Normalized composite score for resume 112 a = \frac{composite score for resume 112 a}{max\_composite \_score} * 100. \qquad Equation 13$$

Similar normalized composite scores for other responses 112b, . . . , 112N may be also computed. Although various sections of this disclosure and one or more figures describe ranking responses based on composite scores, any of composite scores or normalized composite scores may be used for scoring, ranking, selecting, and/or rejecting responses. Note that the maximum possible composite score is max_composite_score is same for all responses and calculated for the job initiation request 104.

In an example, the maximum possible composite score max_composite_score may be computed by using an upper limit for various condition match scores in equations 8-12. For example, if the condition match scores ranges between 0 and 10 (e.g., 10 being the upper limit for various condition match scores), then all condition match scores of equations 8-12 may be replaced by 10, to compute the maximum possible composite score max_composite_score for the job initiation request 104.

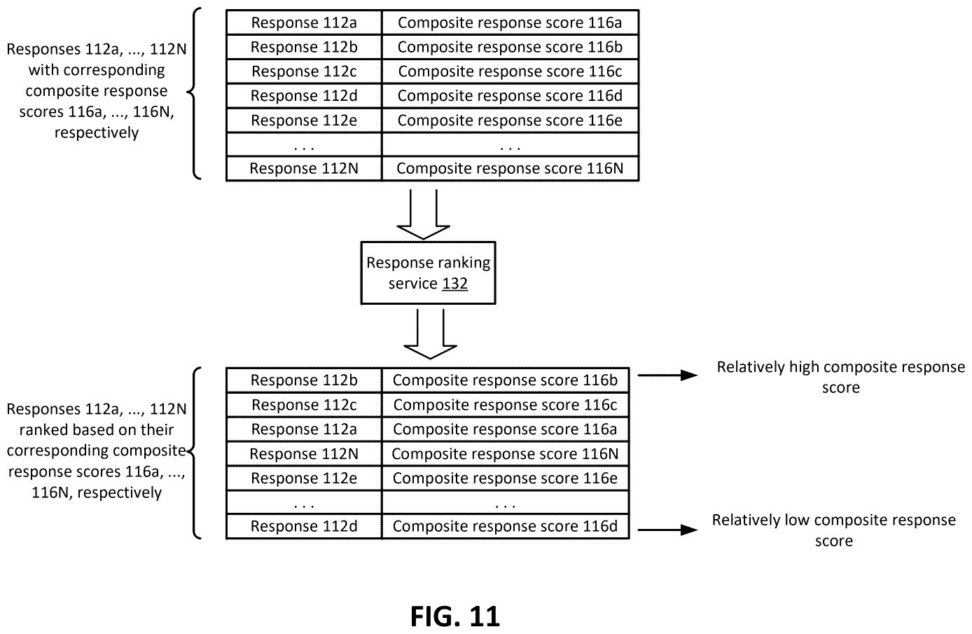

FIG. 11 illustrates ranking of responses 112a, . . . , 112N, based on their corresponding composite response scores 116a, . . . , 116N, respectively. For example, the response ranking service 132 receives the composite response scores 116a, . . . , 116N, and ranks the responses 112a, . . . , 112N based on the composite response scores 116a, . . . , 116N. For example, responses having relatively higher composite response scores are ranked above responses having relatively lower composite response scores. An example ranking of the responses 112a, . . . , 112N is illustrated in FIG. 11.

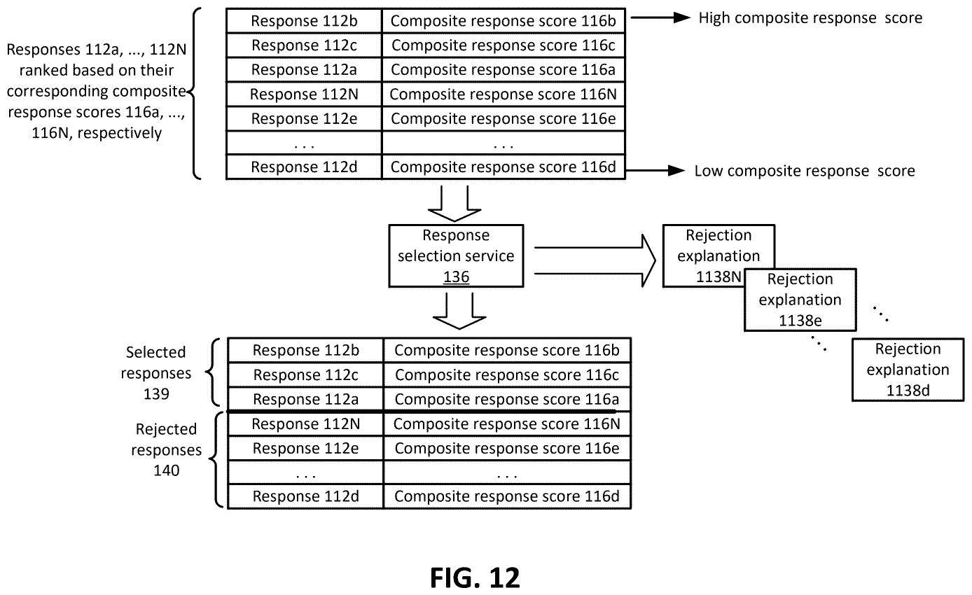

FIG. 12 illustrates selection and/or rejection of responses 112a, . . . , 112N, based on a ranking of the responses 112a, . . . , 112N for a job initiation request 104. For example, the response selection service 136 receives the ranked responses 112a, . . . , 112N. In the example of FIG. 12, the response selection service 136 selects responses (see selected response 139 in FIG. 12) with relatively high composite scores, such as responses 112b, 112c, 112a. The response selection service 136 rejects responses (see rejected response 140 in FIG. 12) with relatively low composite scores, such as responses 112N, 112e, 112d.

In an example, a threshold criteria may be used to select or reject responses. For example, responses with at least a configurable threshold composite score may be selected, while responses with less than the threshold composite score may be rejected. In another example, only a top Q number of responses (where Q may be a configurable positive integer) may be selected, and remaining responses may be rejected.

In an example, the selected responses proceed to a next stage of the hiring process, such as undergo a manual review by a recruiter, advance to an interview stage, and/or the like, and may vary from one implementation to the next. The rejected responses may be withdrawn from consideration for the job initiation request 104.

In an example, whenever a candidate submits a response to the job initiation request 104 (e.g., where the response may be in the form of a response described above, answers to a plurality of questions, etc.), the response matching and ranking service 100 may analyze such a response, to assign a composite response score to the response. Note that the response from a candidate may be, in one example, a response, in which case the response matching and ranking service 100 assigns the composite response score to the response. However, in another example, the response may be in the form of answers to questions being asked, and in such a case, the response matching and ranking service 100 assigns a composite response score to the response, where the composite response score is calculated similar to the composite response score. Thus, the composite response score may be a type of composite response score. In an example, in response to receiving the composite response score, the response matching and ranking service 100 may determine whether the response meets basic criteria for the job initiation request 104 (such as determines whether the response has a corresponding composite response score of higher than a threshold value, as described above with respect to FIG. 12). If the response meets the basic criteria, the response may be further processed and enter the hiring process. In an example, the response matching and ranking service 100 may cause presentation of at least a portion of the ranked list of responses (see FIG. 12) and/or the selected responses on a display associated with the response matching and ranking service 100.

In an example, if a response is rejected, the response matching and ranking service 100 is aware of the reasons the response is rejected. For example, if the response scores relatively low (such as lower than a preconfigured threshold) on one or more condition match scores, then it can be interpreted that the response may not have satisfied the conditions corresponding to the relatively low on one or more condition match scores. Accordingly, the response matching and ranking service 100 may facilitate in generate of relevant rejection note or rejection explanation 1138 (such as rejection explanations 1138N, 1138e, 1138d corresponding to rejected responses 112N, 112e, 112d) on why the response was rejected.

For example, referring to FIG. 8, the condition match score mb-112b is relatively low (e.g., 6), and the response 112b may be rejected at least in part for this reason. Accordingly, an explanation behind such a rejection may be as follows: “a condition for the job position include 3+years of executive leadership experience in AI, automation, machine learning, or related field, whereas you have about 3.5 years is a different filed of leading a group of coders developing a cloud computing security software.” Thus, a rejection note to a candidate of the response 112b may include such an explanation generated by the language model 138.

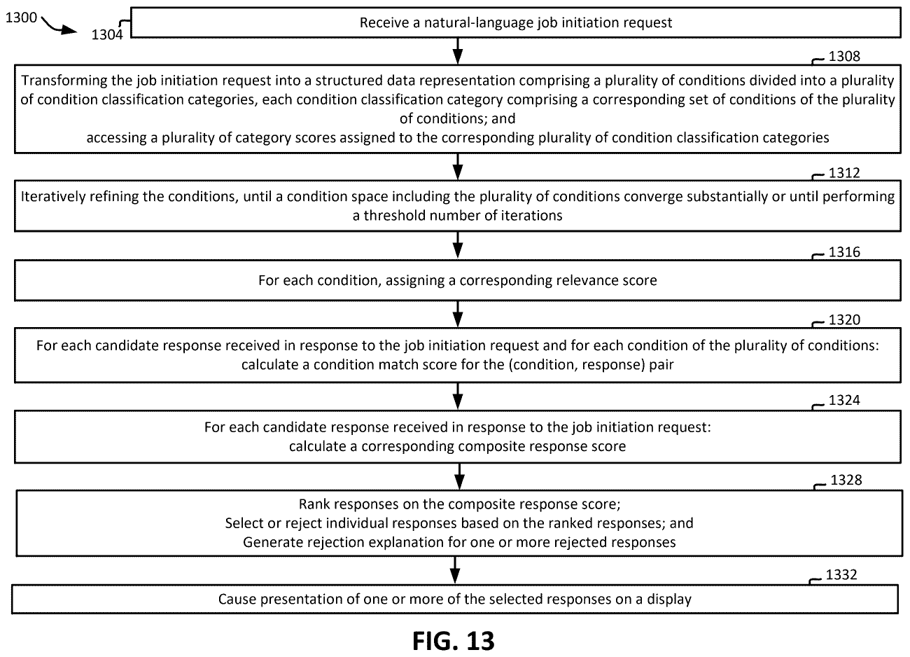

FIG. 13 illustrates a flow chart depicting a method 1300 for automated matching, scoring, and ranking of responses, and selecting or rejecting individual responses for a job initiation request. At 1304, a natural-language job initiation request (such as the job initiation request 104) is received (e.g., by the response matching and ranking service 100).

At 1308, the job initiation request is transformed into a structured data representation comprising a plurality of conditions divided into a plurality of condition classification categories, wherein each condition classification category comprises a corresponding set of conditions of the plurality of conditions. For example, the job condition identification and scoring service 108 and the language model 138 extract a plurality of conditions Cma, . . . , CmU, Cpa, . . . , CpV, Csa, . . . , CsW, Cra, . . . , CrX for the condition classification categories Cm, Cp, Cs, Cr, as described above (also see FIG. 2). Also at 1308, the response matching and ranking service 100 accesses a plurality of category scores (such as scores C1, C2, C3, and C4) assigned to the corresponding plurality of condition classification categories (e.g., see FIG. 5).

At 1312, the conditions are iteratively refined, until a condition space including the plurality of conditions converge substantially (e.g., below a threshold) or until performing a threshold number of iterations, e.g., as described above with respect to FIG. 4A.

At 1316, for each condition of the plurality of conditions, a corresponding relevance score is assigned (e.g., as described above with respect to equation 2). For example, various relevance scores 504ma, . . . , 504rX assigned to various conditions Cma, . . . , Crx are illustrated in FIG. 5.

At 1320, for each candidate response (such as responses 112a, . . . , 112N, or other forms of responses, such as CVs, answers to questions, cover letters, etc.) received in response to the job initiation request and for each condition of the plurality of conditions, a corresponding condition match score is calculated for the (condition, response) pair, e.g., as described above with respect to equations 3-7. Various example condition match scores are illustrated in FIG. 7.

At 1324, for each candidate response received in response to the job initiation request, a corresponding composite response score is calculated, e.g., as described above with respect to equations 8, 8A, and 9-12. In an example, the composite response scores may be normalized, e.g., as described above with respect to equation 13.

At 1328, the responses are ranked based on the composite response score (or the normalized composite response score), e.g., as described above with respect to FIG. 11. Also at 1328, individual responses are selected or rejected, based on the ranked responses, e.g., as described above with respect to FIG. 12. Also at 1328, rejection explanations for one or more rejected responses 140 are generated, e.g., as described above with respect to FIG. 12.

At 1332, one or more of the selected responses 139 are caused to be presented on a display associated with the response matching and ranking service 100.

### Computer System Architecture

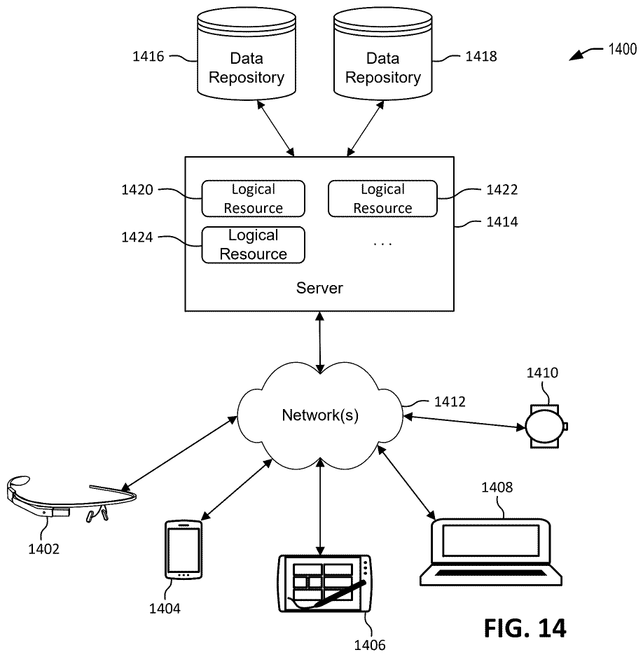

FIG. 14 depicts a simplified diagram of a distributed system 1400 for implementing an embodiment. In the illustrated embodiment, distributed system 1400 includes one or more client computing devices 1402, 1504, 1406, 1408, and/or 1410 coupled to a server 1414 via one or more communication networks 1412. Clients computing devices 1402, 1504, 1406, 1408, and/or 1410 may be configured to execute one or more applications.

In various aspects, server 1414 may be adapted to run one or more services or software applications that enable techniques for automated matching, scoring, and ranking of responses, and selecting or rejecting individual responses for a job initiation request.

In certain aspects, server 1414 may also provide other services or software applications that can include non-virtual and virtual environments. In some aspects, these services may be offered as web-based or cloud services, such as under a Software as a Service (SaaS) model to the users of client computing devices 1402, 1504, 1406, 1408, and/or 1410. Users operating client computing devices 1402, 1504, 1406, 1408, and/or 1410 may in turn utilize one or more client applications to interact with server 1414 to utilize the services provided by these components.

In the configuration depicted in FIG. 14, server 1414 may include one or more components 1420, 1422 and 1424 that implement the functions performed by server 1414. These components may include software components that may be executed by one or more processors, hardware components, or combinations thereof. It should be appreciated that various different system configurations are possible, which may be different from distributed system 1400. The embodiment shown in FIG. 14 is thus one example of a distributed system for implementing an embodiment system and is not intended to be limiting.

Users may use client computing devices 1402, 1504, 1406, 1408, and/or 1410 for techniques for automated matching, scoring, and ranking of responses, and selecting or rejecting individual responses for a job initiation request, in accordance with the teachings of this disclosure. A client device may provide an interface that enables a user of the client device to interact with the client device. The client device may also output information to the user via this interface. Although FIG. 14 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1414 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1414 can include one or more virtual machines running virtual operating systems, or other computing architectures involving virtualization such as one or more flexible pools of logical storage devices that can be virtualized to maintain virtual storage devices for the server. In various aspects, server 1414 may be adapted to run one or more services or software applications that provide the functionality described in the foregoing disclosure.

The computing systems in server 1414 may run one or more operating systems including any of those discussed above, as well as any commercially available server operating system. Server 1414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1414 may include one or more applications to analyze and consolidate data feeds and/or event updates received from users of client computing devices 1402, 1504, 1406, 1408, and/or 1410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1414 may also include one or more applications to display the data feeds and/or real-time events via one or more display devices of client computing devices 1402, 1504, 1406, 1408, and/or 1410.

Distributed system 1400 may also include one or more data repositories 1416, 1418. These data repositories may be used to store data and other information in certain aspects. For example, one or more of the data repositories 1416, 1418 may be used to store information for techniques for automated matching, scoring, and ranking of responses, and selecting or rejecting individual responses for a job initiation request. Data repositories 1416, 1418 may reside in a variety of locations. For example, a data repository used by server 1414 may be local to server 1414 or may be remote from server 1414 and in communication with server 1414 via a network-based or dedicated connection. Data repositories 1416, 1418 may be of different types. In certain aspects, a data repository used by server 1414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1416, 1418 may also be used by applications to store application data. The data repositories used by applications may be of different types such as, for example, a key-value store repository, an object store repository, or a general storage repository supported by a file system.

In one embodiment, server 1414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

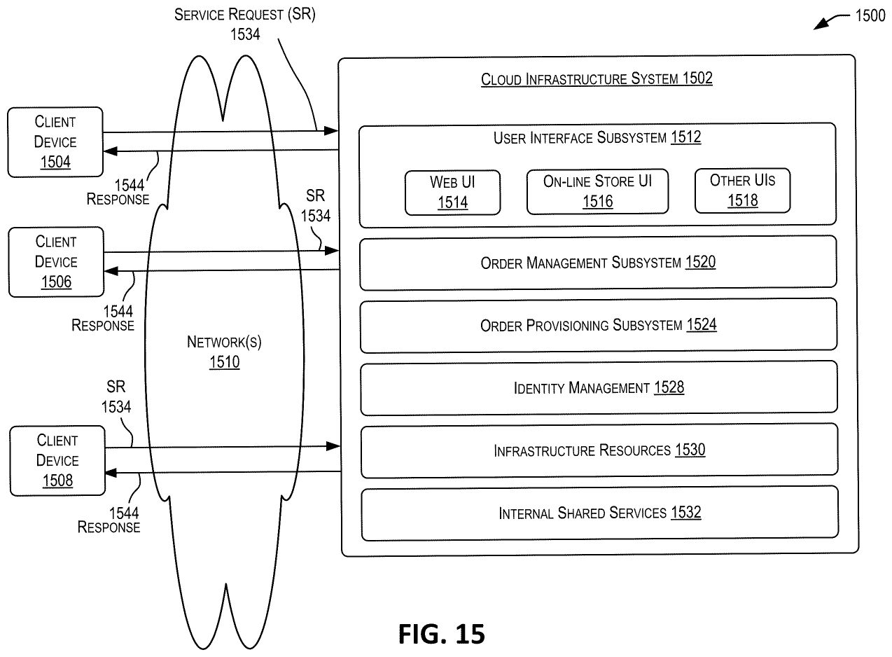

FIG. 15 is a simplified block diagram 1500 of a cloud-based system environment in which automated matching, scoring, and ranking of responses, and selecting or rejecting individual responses for a job initiation request are performed, in accordance with certain aspects. In the embodiment depicted in FIG. 15, cloud infrastructure system 1502 may provide one or more cloud services that may be requested by users using one or more client computing devices 1504, 1506, and 1508. Cloud infrastructure system 1502 may comprise one or more computers and/or servers that may include those described above for server 1414. The computers in cloud infrastructure system 1502 may be organized as general purpose computers, specialized server computers, server farms, server clusters, or any other appropriate arrangement and/or combination.

Network(s) 1510 may facilitate communication and exchange of data between clients 1504, 1506, and 1508 and cloud infrastructure system 1502. Network(s) 1510 may include one or more networks. The networks may be of the same or different types. Network(s) 1510 may support one or more communication protocols, including wired and/or wireless protocols, for facilitating the communications.

The embodiment depicted in FIG. 15 is only one example of a cloud infrastructure system and is not intended to be limiting. It should be appreciated that, in some other aspects, cloud infrastructure system 1502 may have more or fewer components than those depicted in FIG. 15, may combine two or more components, or may have a different configuration or arrangement of components. For example, although FIG. 15 depicts three client computing devices, any number of client computing devices may be supported in alternative aspects.

The term cloud service is generally used to refer to a service that is made available to users on demand and via a communication network such as the Internet by systems (e.g., cloud infrastructure system 1502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1502. Cloud infrastructure system 1502 then performs processing to provide the services requested in the tenant's subscription order. Cloud infrastructure system 1502 may be configured to provide one or even multiple cloud services.

Cloud infrastructure system 1502 may provide the cloud services via different deployment models. In a public cloud model, cloud infrastructure system 1502 may be owned by a third party cloud services provider and the cloud services are offered to any general public tenant, where the tenant can be an individual or an enterprise. In certain other aspects, under a private cloud model, cloud infrastructure system 1502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1502 and the services provided may be shared by several organizations in a related community. Various other models such as hybrids of the above mentioned models may also be used.

Client computing devices 1504, 1506, and 1508 may be of different types (such as devices 1402, 1504, 1406, and 1408 depicted in FIG. 14) and may be capable of operating one or more client applications. A user may use a client device to interact with cloud infrastructure system 1502, such as to request a service provided by cloud infrastructure system 1502.

In some aspects, the processing performed by cloud infrastructure system 1502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 15, cloud infrastructure system 1502 may include infrastructure resources 1530 that are utilized for facilitating the provision of various cloud services offered by cloud infrastructure system 1502. Infrastructure resources 1530 may include, for example, processing resources, storage or memory resources, networking resources, and the like.

In certain aspects, to facilitate efficient provisioning of these resources for supporting the various cloud services provided by cloud infrastructure system 1502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1502 may itself internally use services 1532 that are shared by different components of cloud infrastructure system 1502 and which facilitate the provisioning of services by cloud infrastructure system 1502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1502 may comprise multiple subsystems. These subsystems may be implemented in software, or hardware, or combinations thereof. As depicted in FIG. 15, the subsystems may include a user interface subsystem 1512 that enables users of cloud infrastructure system 1502 to interact with cloud infrastructure system 1502. User interface subsystem 1512 may include various different interfaces such as a web interface 1514, an online store interface 1516 where cloud services provided by cloud infrastructure system 1502 are advertised and are purchasable by a consumer, and other interfaces 1518. For example, a tenant may, using a client device, request (service request 1534) one or more services provided by cloud infrastructure system 1502 using one or more of interfaces 1514, 1516, and 1518. For example, a tenant may access the online store, browse cloud services offered by cloud infrastructure system 1502, and place a subscription order for one or more services offered by cloud infrastructure system 1502 that the tenant wishes to subscribe to. The service request may include information identifying the tenant and one or more services that the tenant desires to subscribe to. For example, a tenant may place a subscription order for a chatbot related service offered by cloud infrastructure system 1502. As part of the order, the client may provide information identifying the input (e.g. utterances).

In certain aspects, such as the embodiment depicted in FIG. 15, cloud infrastructure system 1502 may comprise a service management subsystem (OMS) 1520 that is configured to process the new order. As part of this processing, OMS 1520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1520 may then invoke the service provisioning subsystem (OPS) 1524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1502 may send a response or notification 1544 to the requesting tenant to indicate when the requested service is now ready for use. In some instances, information (e.g., a link) may be sent to the tenant that enables the tenant to start using and availing the benefits of the requested services.

Cloud infrastructure system 1502 may provide services to multiple tenants. For each tenant, cloud infrastructure system 1502 is responsible for managing information related to one or more subscription orders received from the tenant, maintaining tenant data related to the orders, and providing the requested services to the tenant or clients of the tenant. Cloud infrastructure system 1502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1502 may provide services to multiple tenants in parallel. Cloud infrastructure system 1502 may store information for these tenants, including possibly proprietary information. In certain aspects, cloud infrastructure system 1502 comprises an identity management subsystem (IMS) 1528 that is configured to manage tenant's information and provide the separation of the managed information such that information related to one tenant is not accessible by another tenant. IMS 1528 may be configured to provide various security-related services such as identity services, such as information access management, authentication and authorization services, services for managing tenant identities and roles and related capabilities, and the like.

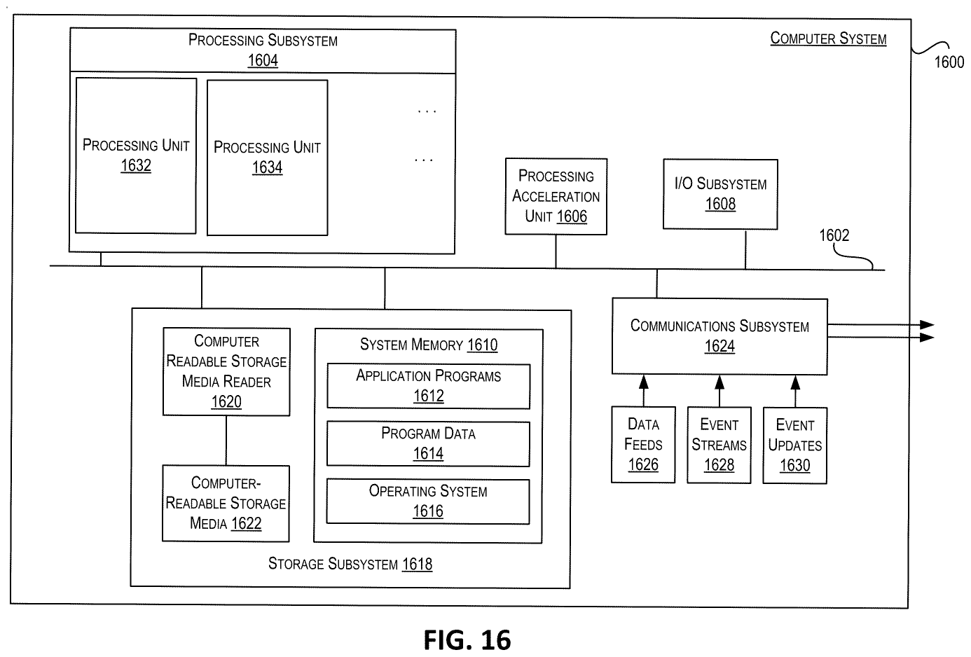

FIG. 16 illustrates an exemplary computer system 1600 that may be used to implement certain aspects. As shown in FIG. 16, computer system 1600 includes various subsystems including a processing subsystem 1604 that communicates with a number of other subsystems via a bus subsystem 1602. These other subsystems may include a processing acceleration unit 1606, an I/O subsystem 1608, a storage subsystem 1618, and a communications subsystem 1624. Storage subsystem 1618 may include non-transitory and/or transitory computer-readable storage media including storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative aspects of the bus subsystem may utilize multiple buses. Bus subsystem 1602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1604 controls the operation of computer system 1600 and may comprise one or more processors, application specific integrated circuits (ASICs), or field programmable gate arrays (FPGAs). The processors may be single core or multicore processors. The processing resources of computer system 1600 can be organized into one or more processing units 1632, 1634, etc. A processing unit may include one or more processors, one or more cores from the same or different processors, a combination of cores and processors, or other combinations of cores and processors. In some aspects, processing subsystem 1604 can include one or more special purpose co-processors such as graphics processors, digital signal processors (DSPs), or the like. In some aspects, some or all of the processing units of processing subsystem 1604 can be implemented using customized circuits, such as application specific integrated circuits (ASICs), or field programmable gate arrays (FPGAs).

In some aspects, the processing units in processing subsystem 1604 can execute instructions stored in system memory 1610 or on computer readable storage media 1622. In various aspects, the processing units can execute a variety of programs or code instructions and can maintain multiple concurrently executing programs or processes. At any given time, some or all of the program code to be executed can be resident in system memory 1610 and/or on computer-readable storage media 1622 including potentially on one or more storage devices. Through suitable programming, processing subsystem 1604 can provide various functionalities described above. In instances where computer system 1600 is executing one or more virtual machines, one or more processing units may be allocated to each virtual machine.

In certain aspects, a processing acceleration unit 1606 may optionally be provided for performing customized processing or for off-loading some of the processing performed by processing subsystem 1604 so as to accelerate the overall processing performed by computer system 1600.

I/O subsystem 1608 may include devices and mechanisms for inputting information to computer system 1600 and/or for outputting information from or via computer system 1600. In general, use of the term input device is intended to include all possible types of devices and mechanisms for inputting information to computer system 1600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1618 provides a repository or data store for storing information and data that is used by computer system 1600. Storage subsystem 1618 provides a tangible non-transitory computer-readable storage medium for storing the basic programming and data constructs that provide the functionality of some aspects. Storage subsystem 1618 may store software (e.g., programs, code modules, instructions) that when executed by processing subsystem 1604 provides the functionality described above. The software may be executed by one or more processing units of processing subsystem 1604. Storage subsystem 1618 may also provide a repository for storing data used in accordance with the teachings of this disclosure.

Storage subsystem 1618 may include one or more non-transitory memory devices, including volatile and non-volatile memory devices. As shown in FIG. 16, storage subsystem 1618 includes a system memory 1610 and a computer-readable storage media 1622. System memory 1610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1600, such as during start-up, may typically be stored in the ROM. The RAM typically contains data and/or program modules that are presently being operated and executed by processing subsystem 1604. In some implementations, system memory 1610 may include multiple different types of memory, such as static random access memory (SRAM), dynamic random access memory (DRAM), and the like.

By way of example, and not limitation, as depicted in FIG. 16, system memory 1610 may load application programs 1612 that are being executed, which may include various applications such as Web browsers, mid-tier applications, relational database management systems (RDBMS), etc., program data 1614, and an operating system 1616. By way of example, operating system 1616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1622 may store programming and data constructs that provide the functionality of some aspects. Computer-readable media 1622 may provide storage of computer-readable instructions, data structures, program modules, and other data for computer system 1600. Software (programs, code modules, instructions) that, when executed by processing subsystem 1604 provides the functionality described above, may be stored in storage subsystem 1618. By way of example, computer-readable storage media 1622 may include non-volatile memory such as a hard disk drive, a magnetic disk drive, an optical disk drive such as a CD ROM, digital video disc (DVD), a Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1618 may also include a computer-readable storage media reader 1620 that can further be connected to computer-readable storage media 1622. Reader 1620 may receive and be configured to read data from a memory device such as a disk, a flash drive, etc.

In certain aspects, computer system 1600 may support virtualization technologies, including but not limited to virtualization of processing and memory resources. For example, computer system 1600 may provide support for executing one or more virtual machines. In certain aspects, computer system 1600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1600. Accordingly, multiple operating systems may potentially be run concurrently by computer system 1600.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to establish a communication channel to one or more client devices via the Internet for receiving and sending information from and to the client devices. For example, the communications subsystem may be used to transmit a response to a user regarding the inquiry for a chatbot.

Communications subsystem 1624 may support both wired and/or wireless communication protocols. For example, in certain aspects, communications subsystem 1624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1624 can provide wired network connectivity (e.g., Ethernet) in addition to or instead of a wireless interface.

Communications subsystem 1624 can receive and transmit data in various forms. For example, in some aspects, in addition to other forms, communications subsystem 1624 may receive input communications in the form of structured and/or unstructured data feeds 1626, event streams 1628, event updates 1630, and the like. For example, communications subsystem 1624 may be configured to receive (or send) data feeds 1626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1624 may be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1624 may also be configured to communicate data from computer system 1600 to other computer systems or networks. The data may be communicated in various different forms such as structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1600 depicted in FIG. 16 is intended only as a specific example. Many other configurations having more or fewer components than the system depicted in FIG. 16 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

1. A computer-program product tangibly embodied in a non-transitory machine-readable storage medium, including instructions configured to cause one or more data processors to perform a set of operations including:
receiving, via an input interface, a natural-language job initiation request;
transforming, by a computing system and using a trained language model, the natural-language job initiation request into a structured data representation comprising a plurality of conditions associated with the job initiation request, wherein the transforming comprises iteratively extracting and refining the plurality of conditions until a difference between condition spaces of consecutive iterations satisfies a convergence threshold or a threshold number of iterations is performed, wherein the plurality of conditions are generated such that the conditions are orthogonal to each other in a vector space of a condition space associated with the job initiation request;
determining, for each condition of the plurality of conditions, a corresponding relevance score based at least in part on semantic alignment between the condition and a contextual representation of the job initiation request;
accessing, by the computing system, textual content of a candidate response to the job initiation request;
for each condition of the plurality of conditions:
extracting evidence from the textual content of the candidate response corresponding to the condition, the evidence being at least a partial match to the condition,
generating a forward-match metric that estimates an extent to which the evidence matches the condition,
generating a reverse-match metric that estimates an extent to which the condition matches the evidence, and
calculating a condition match score associated with the condition, based at least in part on the forward-match metric and the reverse-match metric;
computing a composite response score for the candidate response by aggregating a weighted combination of:
the relevance scores associated with the conditions, and
the corresponding condition match scores;
generating, based on the composite response score, a ranked list of candidate responses; and
causing presentation of at least a portion of the ranked list on a display associated with the computing system.

2. The computer-program product of claim 1, wherein:
the plurality of conditions comprises (i) a first set of conditions assigned to a first classification category, and (ii) a second set of conditions assigned to a second classification category;
a first category score and a second category score are assigned to the first classification category and the second classification category, respectively; and
the weighted combination further includes a weight of the category score.

3. The computer-program product of claim 2, wherein the composite response score for the candidate response is based on an aggregation of at least:
(i) a product of the first category score, a first relevance score of a first condition assigned to the first classification category, and a first condition match score between the textual content of the candidate response and the first condition; and
(ii) a product of the second category score, a second relevance score of a second condition assigned to the second classification category, and a second condition match score between the textual content of the candidate response and the second condition.

4. The computer-program product of claim 2, wherein:
the first classification category is representative of one of (i) one or more mandatory requirements extracted by the trained language model from the job initiation request, (ii) one or more preferred requirements extracted by the trained language model from the job initiation request, (iii) one or more job responsibilities extracted by the trained language model from the job initiation request, and (iv) one or more soft skill requirements extracted by the trained language model from the job initiation request; and
the second classification category is representative of another one of (i) the one or more mandatory requirements extracted by the trained language model from the job initiation request, (ii) the one or more preferred requirements extracted by the trained language model from the job initiation request, (iii) the one or more job responsibilities extracted by the trained language model from the job initiation request, and (iv) the one or more soft skill requirements extracted by the trained language model from the job initiation request.

5-6. (canceled)

7. The computer-program product of claim 1, wherein determining, for each condition, the corresponding relevance score comprises:
determining, for each condition of the plurality of conditions, the corresponding relevance score based further at least in part on a criticality measure of the condition with respect to the job initiation request, the criticality measure estimated using a trained embedding model.

8. The computer-program product of claim 1, wherein determining, for each condition, the corresponding relevance score comprises:
determining, for each condition of the plurality of conditions, the corresponding relevance score based further at least in part on a market demand of a requirement specified within the corresponding condition.

9. (canceled)

10. The computer-program product of claim 1, wherein calculating the condition match score further comprises:
calculating the condition match score to be a lower of the forward-match metric and the reverse-match metric.

11. (canceled)

12. The computer-program product of claim 1, wherein the set of operations further include:
selecting first one or more candidate responses from the ranked list of candidate responses for a subsequent stage of a hiring process associated with the job initiation request; and
rejecting second one or more candidate responses from the ranked list of candidate responses for the subsequent stage of the hiring process associated with the job initiation request,
wherein at least one of the selected first one or more candidate responses has a higher composite response score than at least one of the rejected second one or more candidate responses.

13. The computer-program product of claim 12, wherein selecting the first one or more candidate responses and rejecting the second one or more candidate responses comprises:
in response to each of the first one or more candidate responses having the corresponding composite response score higher than a threshold value, selecting the first one or more candidate responses; and
in response to each of the second one or more candidate responses having the corresponding composite response score lower than the threshold value, rejecting the second one or more candidate responses.

14. The computer-program product of claim 13, wherein the second one or more candidate responses include a given candidate response, wherein the set of operations further include:
identifying a given condition match score of a plurality of condition match scores associated with the given candidate response, such that the given condition match score is less than a threshold value, the given condition match score associated with a given condition; and
facilitating in generation of a rejection note in support of rejecting the given candidate response, the rejection note including text from the given condition.

15. The computer-program product of claim 1, wherein the job initiation request includes a job description for an open job position, and wherein the candidate response is a resume and/or a series of answers received in response to the job initiation request.

16. A computer-implemented method for automated evaluation of candidate responses to a natural-language job initiation request, the method comprising:
receiving, via an input interface, a natural-language job initiation request;
processing the job initiation request using one or more language models to:
(i) detect a set of conditions from the job initiation request, and
(ii) assign, for each of the set of conditions, a corresponding relevance score;
wherein detecting the set of conditions comprises iteratively extracting and refining the set of conditions until a difference between condition spaces of consecutive iterations satisfies a convergence threshold or a threshold number of iterations is performed, wherein the set of conditions are generated such that conditions within set of conditions are orthogonal to each other in a vector space of a condition space associated with the job initiation request;
accessing a plurality of candidate responses to the request;
for each condition within the set of conditions and for each candidate response of the plurality of candidate responses:
(i) extracting evidence from the candidate response corresponding to the condition, the evidence being at least a partial match to the condition,
(ii) generating a forward-match metric that estimates an extent to which the evidence in the response matches the condition,
(iii) generating a reverse-match metric that estimates an extent to which the condition matches the evidence in the response, and
(iv) generating a condition match score based on the forward-match metric and the reverse-match metric;
for each candidate response of the plurality of candidate responses, assigning a corresponding composite response score to the candidate response, based at least in part on the condition match scores associated with the candidate response;
selecting first one or more candidate responses of the plurality of candidate responses, and rejecting second one or more candidate responses of the plurality of candidate responses, based at least in part on the corresponding composite response scores; and
causing presentation of at least one of the selected first one or more candidate responses.

17. The method of claim 16, wherein generating the condition match score comprises:
for each condition within the set of conditions and for each candidate response of the plurality of candidate responses, generating the condition match score to be a lower one of the forward-match metric and the reverse-match metric.

18. The method of claim 16, wherein assigning the composite response score to a given candidate response comprises:
assigning the composite response score to the given candidate response by aggregating:
(i) a first weighted product of (a) a first relevance score assigned to a first condition and (b) a first condition match score assigned to the given candidate response and for the first condition; and
(ii) a second weighted product of (a) a second relevance score assigned to a second condition and (b) a second condition match score assigned to the given candidate response and for the second condition.

19. A system comprising:
one or more processors; and
one or more non-transitory computer-readable media storing instructions, which, when executed by the system, cause the system to perform a set of actions including:
receiving, via an input interface, a natural-language job initiation request;
transforming, by a computing system and using a trained language model, the natural-language job initiation request into a structured data representation comprising a plurality of conditions associated with the job initiation request, wherein the transforming comprises iteratively extracting and refining the plurality of conditions until a difference between condition spaces of consecutive iterations satisfies a convergence threshold or a threshold number of iterations is performed, wherein the plurality of conditions are generated such that the conditions are orthogonal to each other in a vector space of a condition space associated with the job initiation request;
determining, for each condition of the plurality of conditions, a corresponding relevance score based at least in part on semantic alignment between the condition and a contextual representation of the job initiation request;
accessing, by the computing system, textual content of a candidate response to the job initiation request;
for each condition of the plurality of conditions:
extracting evidence from the candidate response corresponding to the condition, the evidence being at least a partial match to the condition,
generating a forward-match metric that estimates an extent to which the evidence matches the condition,
generating a reverse-match metric that estimates an extent to which the condition matches the evidence, and
calculating a condition match score associated with the condition, based at least in part on the forward-match metric and the reverse-match metric;
computing a composite response score for the candidate response by aggregating a weighted combination of:
the relevance scores associated with the conditions, and
the corresponding condition match scores;
generating, based on the composite response score, a ranked list of candidate responses; and
causing presentation of at least a portion of the ranked list on a display associated with the computing system.

20. The system of claim 19, wherein the set of actions further include:
selecting first one or more candidate responses from the ranked list of candidate responses for a subsequent stage of a hiring process associated with the job initiation request; and
rejecting second one or more candidate responses from the ranked list of candidate responses for the subsequent stage of the hiring process associated with the job initiation request,
wherein at least one of the selected first one or more candidate responses has a higher composite response score than at least one of the rejected second one or more candidate responses.
